(19) United States
(12) Patent Application Publication
(10) Pub. No.: US 2025/0231031 A1
(43) Pub. Date: Jul. 17, 2025

(54) METHOD FOR GENERATING BERTHING PATH AND APPARATUS THEREFOR

(71) Applicant: Seadronix Corp., Ulsan (KR)

(72) Inventors: Byeolteo PARK, Seoul (KR); Han Keun KIM, Suwon-si (KR); Dong Hoon KIM, Seoul (KR); Yeongha SHIN, Seoul (KR)

(21) Appl. No.: 19/062,971

(22) Filed: Feb. 25, 2025

Related U.S. Application Data
(63) Continuation of application No. PCT/KR2023/012570, filed on Aug. 24, 2023.

(30) Foreign Application Priority Data
Aug. 31, 2022 (KR) 10-2022-0109593
Dec. 29, 2022 (KR) 10-2022-0188466

(51) Int. Cl. G01C 21/20

(52) U.S. Cl. CPC G01C 21/203

(57) ABSTRACT

The present invention relates to a berthing path generation method for a vessel, comprising: a step of obtaining an obstacle map including a plurality of nodes corresponding to positions at sea; a step of selecting a current node corresponding to a current position of the vessel on the obstacle map and a berthing node corresponding to a berthing position; a step of determining a current heading direction of the vessel at the current node and a berthing heading direction at the berthing node; a step of determining a reference distance; a step of determining a plurality of waypoint nodes using the reference distance and a predetermined expected berthing path cost function; and a step of generating the berthing path using the plurality of determined waypoint nodes.

### CROSS-REFERENCE TO RELATED APPLICATIONS

The present application claims priority to Korean Patent Application No. 10-2022-0109593, filed Aug. 31, 2022, and Korean Patent Application No. 10-2022-0188466, filed Dec. 29, 2022, the entire contents of which are incorporated herein by reference.

### TECHNICAL FIELD

The present disclosure relates to a berthing path generation method for a vessel and a device therefor and, more particularly, to a berthing path generation method and a device therefor which utilize different methods of determining waypoint nodes depending on whether a vessel is located within a reference distance from a berthing position.

### BACKGROUND

Many accidents occur during the navigation of a vessel, and the main cause of the accidents is known to be human negligence in navigation. It is expected that when an autonomous vessel or unmanned vessel that navigates on its own, without being navigated by a human, is commercialized, maritime accidents can be significantly reduced. To this end, global companies are carrying out autonomous vessel development projects.

To complete an autonomous vessel, it must be possible to generate a path by taking into account the characteristics of the marine environment, the characteristics of a vessel, and the characteristics of a harbor. In particular, when a path is generated simply by following the shortest distance to a berthing facility when a vessel is berthed, a course change section with a short length exists just before the berthing facility. Accordingly, even a small deviation from the path increases the risk of collision with the berthing facility, and when considering the characteristics of the marine environment and the characteristics of the vessel, there was a problem in which it was virtually impossible for the vessel to berth along the generated path.

### SUMMARY

One objective of the present disclosure is to provide a berthing path generation method and an apparatus therefor which utilize different methods of determining waypoint nodes depending on whether a vessel is located within a reference distance from a berthing position.

Another object of the present disclosure is to provide an autonomous navigation method and an apparatus therefor which perform path following so that a vessel can navigate along a generated path.

Problems to be solved by the present disclosure are not limited to the problems described above, and problems not mentioned can be clearly understood by those skilled in the art to which the present disclosure belongs from this specification and the attached drawings.

According to one embodiment of this invention, there may be provided a berthing path generation method for a vessel, the method comprising: obtaining an obstacle map including a plurality of nodes corresponding to positions in sea; selecting a current node corresponding to a current position of the vessel and a berthing node corresponding to a berthing position on the obstacle map; determining a current heading direction of the vessel at the current node and a berthing heading direction at the berthing node; determining a reference distance by considering at least one of a length of the vessel, a width of the vessel, a weight of the vessel, a steering performance of the vessel, and a length of a berthing facility; determining, by using the reference distance and a predetermined expected berthing path cost function, a plurality of waypoint nodes from the current node to the berthing node and an expected heading direction assigned to the waypoint node on the obstacle map, wherein the waypoint node corresponds to at least one of the plurality of nodes; and generating the berthing path by using the determined plurality of waypoint nodes; wherein the predetermined expected berthing path cost function includes, for the vessel located at a position farther than the reference distance from the berthing position, a first expected berthing path cost function applied to a first expected berthing path from the current node to a reference distance waypoint node, considering the current heading direction, and a second expected berthing path cost function applied to a second expected berthing path from the reference distance waypoint node to the berthing node, and wherein the first expected berthing path cost function is different from the second expected berthing path cost function.

According to other embodiment of this invention, there may be provided A berthing path generation device for a vessel, the device comprising: a memory storing information for the vessel, information for a port, and a method of determining waypoint nodes; and at least one processor; wherein the processor is configured to: obtain an obstacle map including a plurality of nodes corresponding to positions in sea, select a current node corresponding to a current position of the vessel and a berthing node corresponding to a berthing position on the obstacle map, determine a current heading direction of the vessel at the current node and a berthing heading direction at the berthing node; determine a reference distance by considering at least one of a length of the vessel, a width of the vessel, a weight of the vessel, a steering performance of the vessel, and a length of a berthing facility; determine, by using the reference distance and a predetermined expected berthing path cost function, a plurality of waypoint nodes from the current node to the berthing node and an expected heading direction assigned to the waypoint node on the obstacle map, wherein the waypoint node corresponds to at least one of the plurality of nodes; and generate the berthing path by using the determined plurality of waypoint nodes; wherein the predetermined expected berthing path cost function includes, for the vessel located at a position farther than the reference distance from the berthing position, a first expected berthing path cost function applied to a first expected berthing path from the current node to a reference distance waypoint node, considering the current heading direction, and a second expected berthing path cost function applied to a second expected berthing path from the reference distance waypoint node to the berthing node, and wherein the first expected berthing path cost function is different from the second expected berthing path cost function.

The solutions to the problems of the present disclosure are not limited to the solutions described above, and solutions that are not mentioned will be clearly understood by those skilled in the art to which the present disclosure belongs from this specification and the attached drawings.

According to the present disclosure, by using the berthing path generation method and the apparatus therefor which utilize different methods of determining waypoint nodes depending on whether a vessel is located within a reference distance from a berthing position, a path that minimizes collision with a berthing facility can be generated within the reference distance, thereby reducing the risk of collision between the vessel and the berthing facility when berthing.

According to the present disclosure, it is possible to control a vessel by using an autonomous navigation method and an apparatus therefor which perform path following so that the vessel can navigate along a generated path.

The effects of the present disclosure are not limited to the effects described above, and effects not mentioned will be clearly understood by those skilled in the art to which the present disclosure belongs from this specification and the attached drawings.

### BRIEF DESCRIPTION OF THE DRAWINGS

FIG. 1 is a drawing of a berthing guide system according to an embodiment.

FIG. 2 is a block diagram showing the configuration of a path generation device according to an embodiment.

FIG. 3 is a block diagram showing the configuration of a sensor module according to an embodiment.

FIG. 4 is a block diagram showing the configuration of an external server according to an embodiment.

FIG. 5 is a block diagram showing the configuration of a vessel navigation device according to an embodiment.

FIG. 6 is a drawing showing an obstacle map according to an embodiment.

FIG. 7 is a drawing showing an obstacle map to which scores are assigned according to an embodiment.

FIG. 8 is a drawing of an obstacle map including a node corresponding to a vessel according to an embodiment.

FIG. 9 is a flowchart of a path generation method according to an embodiment.

FIG. 10 is a drawing showing an obstacle map according to an embodiment.

FIG. 11 is a drawing showing a path generated by performing the existing method of generating a berthing path on the obstacle map of FIG. 10.

FIG. 12 is a drawing for explaining a reference distance according to an embodiment.

FIGS. 13, 14, and 15 are drawings showing berthing paths and waypoint nodes on an obstacle map according to an embodiment.

FIG. 16 is an exemplary algorithm for obtaining waypoint nodes and a path based on a 3D A* algorithm.

FIG. 17 is a flowchart of the path generation method according to an embodiment.

FIG. 18 is a drawing for explaining a method of determining a reference distance waypoint node according to an embodiment.

FIG. 19 is a drawing showing each node and a generated berthing path on an obstacle map according to an embodiment.

FIG. 20 is a flowchart of a path following control method according to an embodiment.

FIGS. 21 and 22 are drawings for explaining path following control according to an embodiment.

FIG. 23 is a flowchart of a vessel berthing method using the path following control according to an embodiment.

### DETAILED DESCRIPTION

Since embodiments described in this specification are intended to clearly explain the idea of the present disclosure to those skilled in the art to which the present disclosure belongs, the present disclosure is not limited to the embodiments described in this specification, and the scope of the present disclosure should be interpreted to include modified or altered examples that do not depart from the idea of the present disclosure.

Terms used in this specification have been selected from commonly used terms as much as possible, by taking into account the functions in the present disclosure. However, these may vary depending on the intention of those skilled in the art to which the present disclosure belongs, custom, or the emergence of new technologies. However, in a case in which a specific term is used with an arbitrary meaning, the meaning of that term will be described separately. Therefore, the terms used in this specification should be interpreted based on the actual meaning of the terms and the overall contents of this specification, rather than simply the names of the terms.

The drawings attached to this specification are intended to facilitate explanation of the present disclosure, and shapes depicted in the drawings may be exaggerated as necessary to help the understanding of the present disclosure, and therefore the present disclosure is not limited by the drawings.

When it is determined that detailed descriptions of known configurations or functions related to the present disclosure in this specification may obscure the gist of the present disclosure, detailed descriptions thereof may be omitted as necessary.

According to one embodiment of this invention, there may be provided a berthing path generation method for a vessel, the method comprising: obtaining an obstacle map including a plurality of nodes corresponding to positions in sea; selecting a current node corresponding to a current position of the vessel and a berthing node corresponding to a berthing position on the obstacle map; determining a current heading direction of the vessel at the current node and a berthing heading direction at the berthing node; determining a reference distance by considering at least one of a length of the vessel, a width of the vessel, a weight of the vessel, a steering performance of the vessel, and a length of a berthing facility; determining, by using the reference distance and a predetermined expected berthing path cost function, a plurality of waypoint nodes from the current node to the berthing node and an expected heading direction assigned to the waypoint node on the obstacle map, wherein the waypoint node corresponds to at least one of the plurality of nodes; and generating the berthing path by using the determined plurality of waypoint nodes; wherein the predetermined expected berthing path cost function includes, for the vessel located at a position farther than the reference distance from the berthing position, a first expected berthing path cost function applied to a first expected berthing path from the current node to a reference distance waypoint node, considering the current heading direction, and a second expected berthing path cost function applied to a second expected berthing path from the reference distance waypoint node to the berthing node, and wherein the first expected berthing path cost function is different from the second expected berthing path cost function.

The reference distance waypoint node may be one of reference distance nodes corresponding to a position located at the reference distance from the berthing node.

The reference distance waypoint node may be a node corresponding to a position located at the reference distance from the berthing node in the berthing heading direction or in a direction opposite to the berthing heading direction.

The second expected berthing path cost function may include a term that considers the berthing heading direction.

The term that considers the berthing heading direction may be a term that considers a difference between an expected heading direction assigned to a waypoint node on the second expected berthing path and the berthing heading direction.

In the obstacle map, a score based on navigational safety of the vessel may be assigned to each of the plurality of nodes, and expected berthing path cost function may include a term that considers the score.

The determining the plurality of waypoint nodes may include: determining a current speed of the vessel, and calculating a maximum turning angle of the vessel based on the current speed, wherein the expected berthing path cost function may include a term that considers the maximum turning angle.

According to other embodiment of this invention, there may be provided a berthing path generation device for a vessel, the device comprising: a memory storing information for the vessel, information for a port, and a method of determining waypoint nodes; and at least one processor; wherein the processor is configured to: obtain an obstacle map including a plurality of nodes corresponding to positions in sea, select a current node corresponding to a current position of the vessel and a berthing node corresponding to a berthing position on the obstacle map, determine a current heading direction of the vessel at the current node and a berthing heading direction at the berthing node; determine a reference distance by considering at least one of a length of the vessel, a width of the vessel, a weight of the vessel, a steering performance of the vessel, and a length of a berthing facility; determine, by using the reference distance and a predetermined expected berthing path cost function, a plurality of waypoint nodes from the current node to the berthing node and an expected heading direction assigned to the waypoint node on the obstacle map, wherein the waypoint node corresponds to at least one of the plurality of nodes; and generate the berthing path by using the determined plurality of waypoint nodes; wherein the predetermined expected berthing path cost function includes, for the vessel located at a position farther than the reference distance from the berthing position, a first expected berthing path cost function applied to a first expected berthing path from the current node to a reference distance waypoint node, considering the current heading direction, and a second expected berthing path cost function applied to a second expected berthing path from the reference distance waypoint node to the berthing node, and wherein the first expected berthing path cost function is different from the second expected berthing path cost function.

The processor may determine the plurality of waypoint nodes, determine a current speed of the vessel, and calculate a maximum turning angle of the vessel based on the current speed, wherein the expected berthing path cost function may include a term that considers the maximum turning angle.

Hereinafter, the berthing path generation method and the apparatus therefor according to an embodiment will be described.

### 1. Berthing Guide System 10

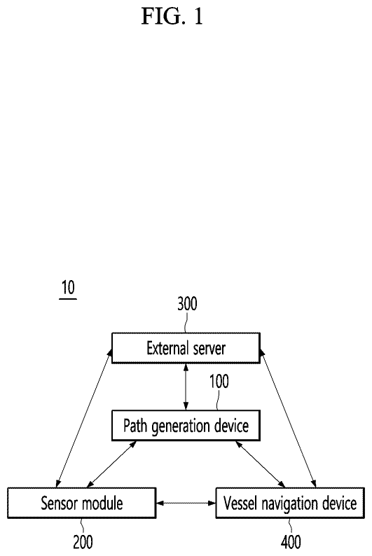

FIG. 1 is a drawing of the berthing guide system 10 according to an embodiment.

The berthing guide system 10 according to one embodiment may generate a berthing path from a current position of a vessel to a berthing position. In order to generate the berthing path, an obstacle map may be obtained, and a reference distance may be determined. Next, a waypoint node from a current node on the obstacle map corresponding to a current position to a berthing node on the obstacle map corresponding to the berthing position may be determined, and the berthing path may be generated by using the current node, the berthing node, and the waypoint node. To generate a safe berthing path, when the vessel comes within the reference distance from the berthing position, a path may be created by taking into account the heading direction of the vessel when the vessel berths at the berthing position. Meanwhile, a path may be generated by considering navigational safety at sea. Additionally, the vessel may be controlled so that the vessel can navigate by following the generated path.

More specifically, referring to FIG. 1, the berthing guide system 10 may include a path generation device 100, a sensor module 200, an external server 300, and a vessel navigation device 400.

Hereinafter, the path generation device 100, the sensor module 200, the external server 300, and the vessel navigation device 400 will be described in detail. The berthing guide system 10 does not have to include all of the components described above, but may include some components selected from the path generation device 100, the sensor module 200, the external server 300, and the vessel navigation device 400. In this case, the number of one component of the path generation device 100, the sensor module 200, the external server 300, and the vessel navigation device 400 included in the berthing guide system 10 may be one or more. For example, the berthing guide system 10 may include a single sensor module 200 or may include two or more sensor modules 200.

The path generation device 100 according to an embodiment may generate a path from the current position of the vessel to the berthing position by using data stored inside or data acquired from the outside.

More specifically, the path generation device 100 may determine waypoint nodes from the current node of the vessel to the berthing node on the obstacle map acquired by using the method of determining waypoint nodes. The path generation device 100 may generate a berthing path by using the determined waypoint nodes. The obstacle map is a map that includes the location of obstacles and object information. Specific details about the obstacle map and the method of generating a berthing path are described later.

The sensor module (sensor device) 200 according to one embodiment may detect the status of the vessel and the surrounding environmental factors. Additionally, various elements that the path generation device 100 requires for berthing path generation may be detected and be transmitted to the path generation device 100.

The external server 300 according to an embodiment stores at least one of information about a vessel, information about a harbor, real-time vessel status information, real-time harbor status information, and real-time environment data, and may transmit data required by the path generation device 100. Specifically, when there is data which is not stored in the path generation device 100 but is required for berthing path generation, or when real-time data is required for berthing path generation even if data is stored, the external server 300 may transmit data required for berthing path generation to the path generation device 100.

The vessel navigation device 400 according to an embodiment may generate a control signal to enable the vessel to navigate along a berthing path generated by the path generation device 100. The generated control signal may be transmitted to the driving device of the vessel to control the navigation of the vessel. The control signal may include the speed control signal and/or heading direction control signal of the vessel.

Hereinafter, it is described that the path generation device 100, the sensor module 200, and the vessel navigation device 400 are located in the vessel, and the external server 300 is located in a control center.

However, this is not limited, and the path generation device 100 may also be located in the control center. In this case, the path generation device 100 may remotely receive data from the sensor module 200 and remotely transmit data related to the generated path to the vessel navigation device 400. Meanwhile, both the path generation device 100 and the vessel navigation device 400 may be located in the control center, and in this case, the vessel navigation device 400 may remotely transmit the generated control signal to the vessel.

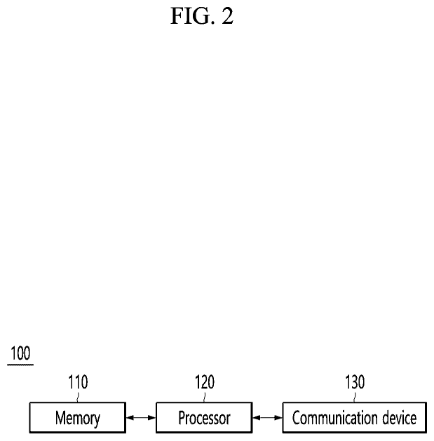

FIG. 2 is a block diagram showing the configuration of the path generation device 100 according to an embodiment.

Referring to FIG. 2, the path generation device 100 may include a memory 110, a processor 120, and a communication device 130.

The memory 110 may store various processing programs, parameters for processing the programs, or data resulting from such processing. For example, the memory 110 may store instruction for the operation of the processor 120, the method of determining waypoint nodes, an algorithm for determining waypoint nodes, etc., which will be described later.

Meanwhile, the memory 110 may further store information about the vessel and information about the harbor.

The information about the vessel may include the length of the vessel, the width of the vessel, the volume of the vessel, the weight of the vessel, the steering performance of the vessel, the maximum steering angle of the vessel, etc.

The information about the harbor may include a harbor map, a harbor structure, the location of a harbor facility, the length of a harbor, the location of a berthing facility, the length of a berthing facility, the location of an obstacle, the property of an obstacle, an obstacle map, the berthing position of the vessel, the heading direction of the vessel when the vessel is berthed at the berthing position, etc.

The information about the vessel and/or the information about the harbor stored in the memory 110 may be data received from the outside.

The memory 110 may be implemented as a nonvolatile semiconductor memory, a hard disk, a flash memory, a random access memory (RAM), a read only memory (ROM), an electrically erasable programmable read-only memory (EEPROM), or any other type of (tangible) nonvolatile storage medium.

The processor 120 may operate according to instructions stored in the memory 110, determine waypoint nodes by using the method of determining waypoint nodes, and generate a berthing path by using the path generation method. The various operations or steps of the berthing path generation disclosed in the embodiment of the present disclosure below may be interpreted as being performed by the processor 120 of the path generation device 100 or under the control of the processor 120 unless otherwise stated. The specific operation method of the processor 120 will be described later.

The processor 120 may be implemented as a central processing unit (CPU), a graphics processing unit (GPU), a digital signal processor (DSP), a state machine, an application specific integrated circuit (ASIC), a radio-frequency integrated circuit (RFIC), or a combination thereof.

The communication device 130 may transmit data and/or information to or receive data and/or information from the outside via wired and/or wireless communication. The communication device 130 may perform bi-directional or unidirectional communication.

For example, the communication device 130 may communicate with the sensor module 200, the external server 300, and/or the vessel navigation device 400. Specifically, sensing data may be received from the sensor module 200, and various data required for path generation may be received from the external server 300. Additionally, the communication device 130 may transmit information related to determined waypoint nodes and/or information related to a generated path to the vessel navigation device 400. The communication device 130 is not limited thereto and may communicate with other external devices.

The path generation device 100 may be installed in the vessel. However, the path generation device 100 is not limited thereto and may be installed outside the vessel. For example, the path generation device 100 may be installed in a harbor control server, the terminal device of an operator, an external server, etc.

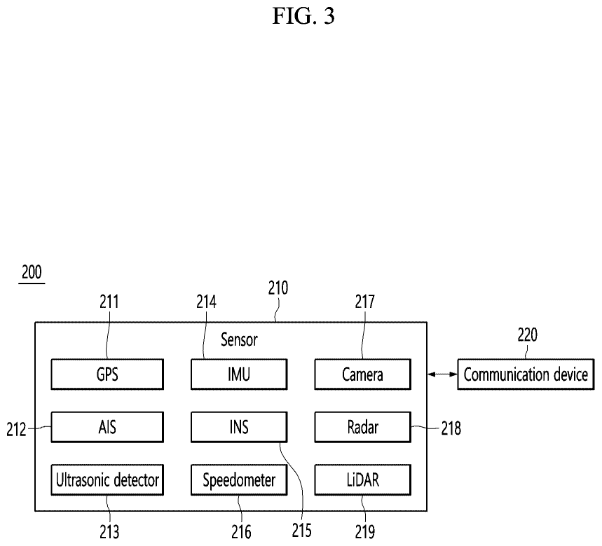

FIG. 3 is a block diagram showing the configuration of the sensor module 200 according to an embodiment.

The sensor module 200 may detect the status of the vessel and surrounding environmental factors. More specifically, the sensor module 200 may perform position detection, heading direction detection, speed detection, steering angle detection, and/or weight detection for the vessel, and may perform current detection, wind direction detection, and wind speed detection for the external environment. Detectable objects are not limited to the objects described above, and the sensor module 200 may detect various elements necessary for berthing path generation.

Referring to FIG. 3, the sensor module 200 according to an embodiment may include at least one sensor 210, and a communication device 220.

The sensor 210 may include at least one of a global positioning system (GPS) 211, an automatic identification system (AIS) 212, an ultrasonic detector 213, an inertial measurement unit (IMU) 214, an inertial navigation system (INS) 215, a speedometer 216, a camera 217, radar 218, a LiDAR 219, and a real-time kinematic GPS (RTK-GPS). The sensor 210 is not limited to the components described above, and may include a sensor for detecting the status of the vessel and/or a sensor for detecting the surrounding environment of the vessel.

The communication device 220 of the sensor module 200 may transmit data and/or information to or receive data and/or information from the outside via wired and/or wireless communication, and may perform data communication with the path generation device 100, the external server 300, and/or the vessel navigation device 400.

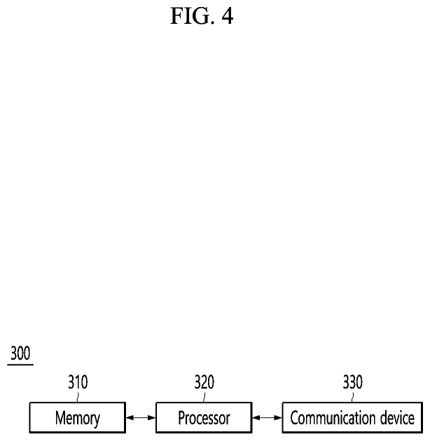

FIG. 4 is a block diagram showing the configuration of the external server 300 according to an embodiment.

The external server 300 may store at least one of information about a vessel, information about a harbor, real-time vessel status information, real-time harbor status information, and real-time environment data, and may transmit data required for generating a berthing path to the path generation device 100.

Specifically, in case that there is data that is not stored in the path generation device 100 but is required for generating a berthing path, or in case that real-time data is required for berthing path generation even if the data is stored, the external server 300 may transmit the data required for the berthing path generation to the path generation device 100.

For example, the external server 300 may determine a harbor in which a vessel is located by using vessel location data received from the vessel, and transmit information about the determined harbor to the path generation device 100.

Meanwhile, the external server 300 may transmit data required for vessel navigation in addition to data required for path generation to the path generation device 100, the sensor module 200, and/or the vessel navigation device 400.

The external server 300 according to an embodiment may be various types of servers such as a control server, a cloud server, etc.

Referring to FIG. 4, the external server 300 according to an embodiment may include a memory 310, a processor 320, and a communication device 330.

The memory 310 of the external server 300 may store information about at least one harbor. The information about a harbor is not limited to only a harbor at which the vessel is currently located, but may include information about nearby harbors or the entire harbors. Information about a specific harbor has been described above, so a duplicate description will be omitted.

The memory 310 may store information about at least one vessel. The information about the vessel may be data received from the vessel, and information about a specific vessel has been described above, so a duplicate description will be omitted.

The memory 310 may store data that the external server 300 receives in real time from the outside. For example, the memory 310 may store at least one of information about real-time vessel status, information about real-time harbor status, and real-time environment data.

The processor 320 of the external server 300 may determine a harbor in which the vessel is located by using data received from the vessel. For example, when the external server 300 receives GPS location data f

rom the vessel, the processor 320 may use the data to determine a harbor at which the vessel is located or a nearby harbor.

The processor 320 may transmit the obstacle map corresponding to the determined harbor to the path generation device 100 and/or the vessel navigation device 400.

For example, the processor 320 may generate an obstacle map including a node corresponding to the current position of the vessel and a node corresponding to the berthing position of the vessel, or select one obstacle map of a plurality of obstacle maps and transmit the one obstacle map to the path generation device 100 or the vessel navigation device 400 via the communication device 330, which will be described later. Details regarding the obstacle map will be described later.

Meanwhile, when the external server 300 is a control server, the external server 300 may receive weather information about a harbor, etc. from a separate weather service server, and transmit the received weather information, etc. to the path generation device 100 and/or the vessel navigation device 400.

The communication device 330 of the external server 300 may transmit data and/or information to the outside or receive data and/or information from the outside via wired and/or wireless communication, and may perform data communication with the path generation device 100, the sensor module 200, and/or the vessel navigation device 400.

Meanwhile, the external server 300 may be placed outside the vessel and may be located in a control center, a navigation management center, etc.

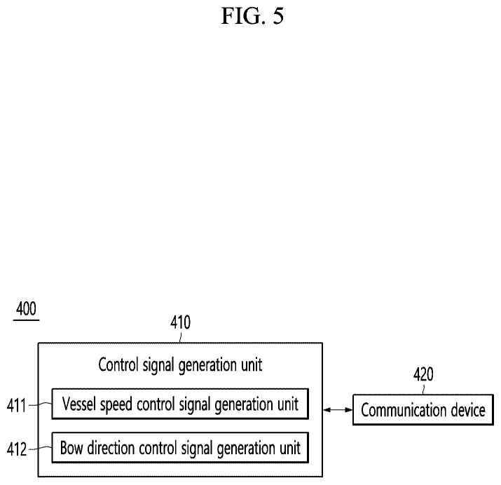

FIG. 5 is a block diagram showing the configuration of the vessel navigation device 400 according to an embodiment.

The vessel navigation device 400 may generate a control signal to enable the vessel to navigate along a berthing path or waypoint nodes received from the path generation device 100. The control signal may include the speed control signal and/or heading direction control signal of the vessel.

For example, the vessel speed control signal may be a signal for controlling the rotation speed of the propeller of the vessel, a signal for controlling the number of rotations per unit time of the propeller, or an engine output control signal, etc., but is not limited thereto, and may include various signals for controlling the power device of the vessel.

For example, the heading direction control signal may be a signal for controlling the rudder of the vessel or a signal for controlling the wheel (helm) of the vessel, but is not limited thereto, and may include various signals for controlling the direction of movement of the vessel.

Referring to FIG. 5, the vessel navigation device 400 according to an embodiment may include a control signal generation unit 410 and a communication device 420. The control signal generation unit 410 may include a vessel speed control signal generation unit 411 and/or a heading direction control signal generation unit 412.

The vessel speed control signal generation unit 411 generates the vessel speed control signal as described above to control the propeller or engine of the vessel.

The heading direction control signal generation unit 412 generates the above-described heading direction control signal to control the rudder or helm of the vessel. Specific details related to the control signal are described later.

The communication device 420 of the vessel navigation device 400 may receive information related to waypoint nodes or information related to a berthing path from the path generation device 100. Meanwhile, the vessel navigation device 400 may receive information on the current status of the vessel and the surrounding environment information from the sensor module 200. Meanwhile, the vessel navigation device 400 may receive weather information or navigation rules from the external server 300. The navigation rules refer to agreements or regulations that must be observed during vessel navigation. For example, the navigation rules may be the International Regulations for Preventing Collisions at Sea (COLREG). Meanwhile, the vessel navigation device 400 may transmit a generated control signal to the vessel to enable the vessel to navigate along the generated berthing path.

### 2. Obstacle Map

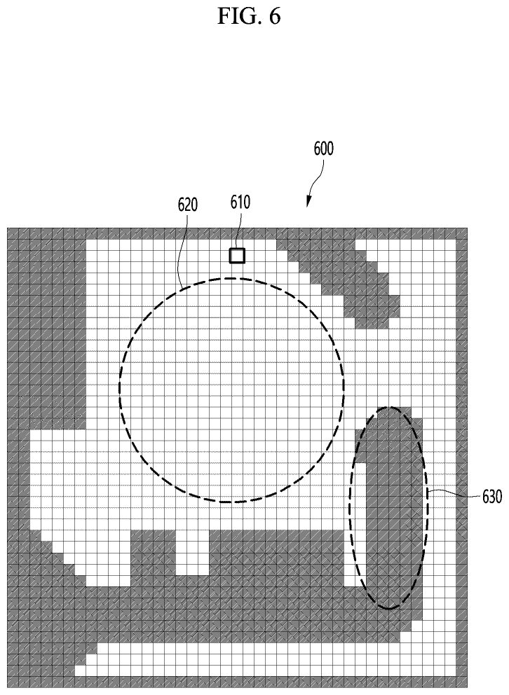

FIG. 6 is a drawing showing an obstacle map 600 according to an embodiment.

The obstacle map may be a grid image or matrix data used in path generation, and is not limited thereto and may be implemented in various forms. FIG. 6 shows the obstacle map 600 implemented as a grid image.

A path at sea may be generated by considering the location of nodes 630 corresponding to obstacles on the obstacle map 600. For example, the path generation device 100 may generate a berthing path by using the obstacle map 600.

Referring to FIG. 6, the obstacle map 600 may include a plurality of nodes 610. Each of the nodes 610 may correspond to a location at sea, or may correspond to a location on land.

When the obstacle map 600 is implemented as a grid image, each of the nodes 610 may refer to each area of the grid image.

Meanwhile, when the obstacle map is a two-dimensional image, “one node” included in the obstacle map may correspond to “one pixel” constituting the two-dimensional image, or “one node” included in the obstacle map may correspond to a plurality of adjacent pixels constituting the two-dimensional image.

Meanwhile, when the obstacle map is implemented as matrix data, the matrix data includes a plurality of matrices, and some of elements of each of the matrices may correspond to position values (e.g., x-coordinate, y-coordinate, etc.), and the remaining of the elements may correspond to attribute values assigned to corresponding position values. In this case, the nodes of the obstacle map described above may correspond to one matrix included in the matrix data described above, or the nodes of the obstacle map may correspond to a plurality of matrices corresponding to adjacent positions among the matrices included in the matrix data described above.

Referring to FIG. 6, the obstacle map 600 may include nodes 620 corresponding to the sea and the nodes 630 corresponding to obstacles. Referring to FIG. 6, the nodes 620 corresponding to the sea are indicated in a light color, and the nodes 630 corresponding to the obstacles are indicated in a dark color.

The nodes 630 corresponding to the obstacles mean that the vessel cannot navigate to a location corresponding to each of the nodes. The distribution of the nodes 630 corresponding to the obstacles may vary depending on the shape of harbor facility and the shape of berthing facility. The obstacles may mean any object that may hinder the navigation of the vessel, such as terrain, buildings, islands, harbors, vessels, buoys, offshore structures, breakwaters, or people.

Meanwhile, although not shown in FIG. 6, each node 610 of the obstacle map 600 may be assigned attribute information. The attribute information refers to information related to an object corresponding to each node, and has no restrictions if it is information about an object.

Objects may include not only obstacles that may hinder the navigation of the vessel as described above, but also areas in which the vessel may navigate, such as the sea. Accordingly, the nodes 620 corresponding to the aforementioned sea may be assigned information related to the sea, and the nodes 630 corresponding to the obstacles may be assigned information related to the obstacles. Meanwhile, nodes corresponding to land may be assigned information related to land.

The attribute information is not limited to the presence or absence of an object, its type, location, arrangement direction, movement direction, and movement speed, and may include a score based on the presence or absence of obstacles and suitability for navigation.

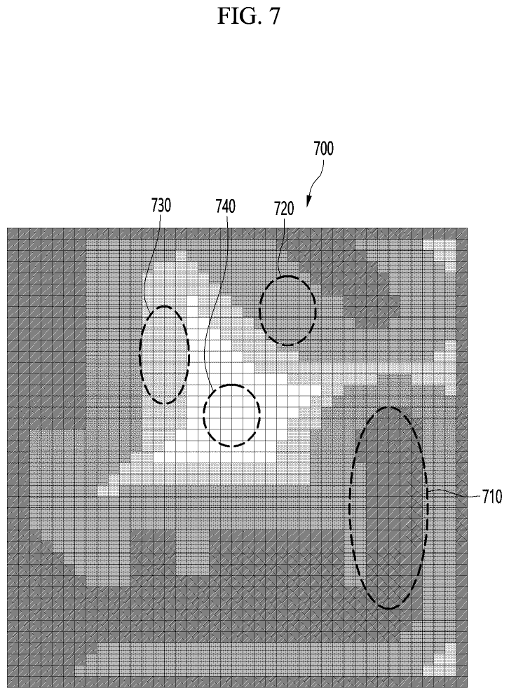

FIG. 7 is a drawing showing an obstacle map 700 to which scores are assigned according to an embodiment. The obstacle map 700, which is given a score, may be called a cost map.

Referring to FIG. 7, some or all of the plurality of nodes included in the obstacle map 700 may be assigned scores based on the presence or absence of obstacles and suitability for navigation.

A score assigned to a particular node reflects the navigational suitability of the particular node, which is determined based on several criteria. Accordingly, when a value of a score assigned to one node is different from a value of a score assigned to another node, it means that the navigation suitability determined for each of the nodes is different.

Navigational suitability for a specific node may be determined by considering the probability that an obstacle will exist at the specific node. Alternatively, navigational suitability for a specific node may be determined by considering the probability that the vessel will collide with an obstacle when the vessel is located at the specific node. Alternatively, the navigational suitability for a specific node may be determined by considering a distance at which specific node is located away from a node corresponding to an obstacle. Of course, the navigational suitability for a specific node may be determined by a combination of two or more of the three methods described above.

A high navigational suitability for a specific node may mean that the vessel has a low probability of colliding with an obstacle when the vessel passes through the specific node. Conversely, a low navigational suitability for a specific node may mean that the vessel has a high probability of colliding with an obstacle when the vessel passes through the specific node.

In this specification, although the navigational suitability is not limited thereto, a higher score is described as meaning a lower navigational suitability, and a lower score is described as meaning a higher navigational suitability.

Although the score is not limited thereto, the score may have a value between 0 and 255. The range described above is provided for illustrative purposes, and the range of the score is not limited to the range described above. A higher score may indicate a higher probability of an obstacle or a more unsuitable condition for navigation, while a lower score may indicate a more suitable condition for navigation.

Meanwhile, a score given to a node may be determined based on a distance from a node corresponding to an obstacle. For example, a node that is located farther from a node corresponding to an obstacle may be assigned a lower score. In this case, different score determination criteria may be applied depending on the characteristics of an obstacle.

For example, a node adjacent to a node corresponding to an obstacle having characteristics that make it difficult for the vessel to approach, such as an island or a breakwater, may be assigned a relatively higher score than a node adjacent to a node corresponding to an obstacle having characteristics that make it easy for the vessel to approach, such as a buoy. In addition, the range of a score that decreases as a distance between a node adjacent to a node corresponding to an obstacle having a characteristic difficult for the vessel to approach and the node corresponding to the obstacle increases may be smaller than the range of a score in a node adjacent to a node corresponding to an obstacle having a characteristic easy for the vessel to approach.

In FIG. 7 according to an example, the higher a score given to a node, the darker the node is displayed, and the lower a score given to a node, the lighter the node is displayed. Referring to FIG. 7, nodes 710 corresponding to an obstacle are given the highest score and thus is displayed in the darkest color. Meanwhile, for nodes 720, 730, and 740 corresponding to the sea, the nodes 720 with the lowest score are displayed in the brightest color, the nodes 730 with a medium score are displayed in a medium-bright color, and the nodes 720 with a high score are displayed in a slightly bright color.

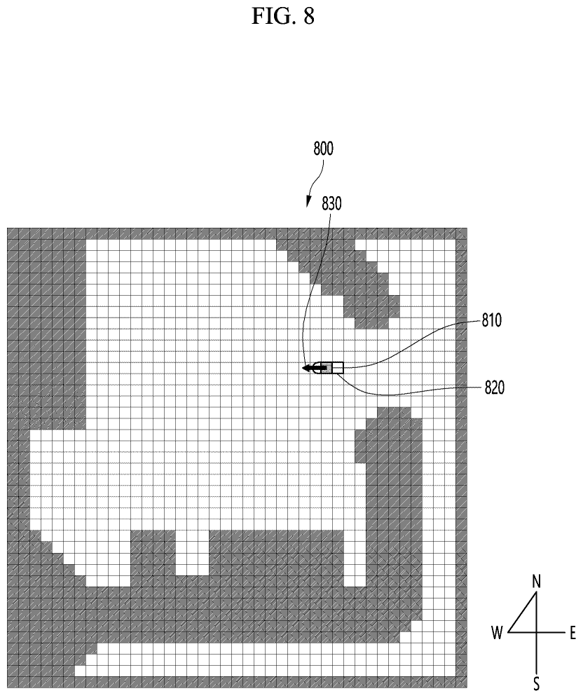

FIG. 8 is a drawing of an obstacle map 800 including a node 810 corresponding to a vessel according to an embodiment.

The shape 820 of the vessel is also reflected on the obstacle map 800 of FIG. 8, but is not limited thereto, and only the node 810 corresponding to the vessel may be displayed on the obstacle map 800.

Referring to FIG. 8, the node 810 corresponding to the vessel on the obstacle map 800 may be assigned a heading direction 830 of the vessel located at a position of the sea corresponding to the node 810 as attribute information.

The heading direction refers to a direction to which the bow of the vessel is pointing. Specifically, the heading direction may refer to a direction in which the vessel is intended to proceed, that is, an angle formed between a bow-stern line of the vessel and a reference line (a meridian line) passing through the vessel. For example, referring to FIG. 8, the node 810 corresponding to the vessel may be assigned a value of 270 degrees or 1.5π as the heading direction 830.

This is not limited thereto, and when a reference direction is set on the obstacle map, the heading direction may refer to an angle formed between the set reference direction and the bow-stern line.

The obstacle map may be generated in a variety of ways. For example, the obstacle map may be generated from an electronic navigational chart, or may be generated by using images such as satellite photos or aerial photographs.

For example, when processing an image to generate an obstacle map, image segmentation may be used to identify a sea area and an obstacle area reflected in an image, and then the obstacle map may be created based on the identified area. Specifically, the obstacle map may be generated by arranging nodes corresponding to the sea in the sea area and arranging nodes corresponding to an obstacle in the obstacle area.

Meanwhile, the obstacle map may be generated by using LiDAR point cloud data. Specifically, the obstacle map, which is represented in two dimensions, may be generated by projecting each of points included in a LiDAR point cloud onto a reference plane. The reference plane may refer to a plane that can be assumed to be the mean sea level.

In order to generate the obstacle map by using the LiDAR point cloud, a LiDAR sensor for detecting the surrounding environment may be arranged on a vessel or harbor facility. A plurality of LiDAR sensors may be installed, and they may be installed without restrictions on positions thereof.

Meanwhile, the obstacle map may be generated by using a camera image. Specifically, after performing image segmentation on an image, the segmented image may be transformed into a viewpoint on a reference plane to generate the obstacle map. The reference plane may refer to a plane that can be assumed to be the mean sea level.

In order to generate the obstacle map by using camera images, a camera that captures images of the surrounding environment may be arranged in the vessel or harbor facility. A plurality of cameras may be installed, and the cameras may be installed without restrictions on positions thereof.

The method of generating the obstacle map is not limited thereto, and various methods of generating a harbor map may be used.

The obstacle map may be generated on the external server 300. The external server 300 may generate the obstacle map by using electronic navigational chart or image data as described above. Meanwhile, the external server 300 may generate the obstacle map by using LiDAR point cloud data or captured images acquired by a harbor facility or a vessel.

The obstacle map is not limited to this, and may be generated by the path generation device 100. Specifically, the path generation device 100 may generate the obstacle map by using data stored in the path generation device 100 or data received from the outside.

Meanwhile, when the path generation device 100 is located on a vessel, the path generation device 100 may generate the obstacle map by using LiDAR point cloud data acquired by the LiDAR sensor of the vessel or images captured by the camera of the vessel. When the path generation device 100 is located outside the vessel, the path generation device 100 may generate the obstacle map by using LiDAR point cloud data or captured images acquired by a harbor facility or a vessel.

### 3. Path Generation Method 1

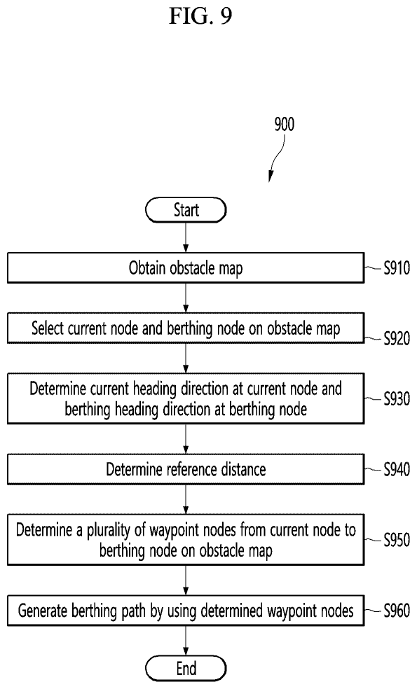

FIG. 9 is a flowchart of a path generation method according to an embodiment.

Referring to FIG. 9, the path generation method according to an embodiment of the present disclosure may be performed through the process of obtaining the obstacle map in S910, selecting the current node and the berthing node on the obstacle map in S920, determining the current heading direction at the current node and the berthing heading direction at the berthing node in S930, determining the reference distance in S940, determining the plurality of waypoint nodes from the current node to the berthing node on the obstacle map in S950, and generating the berthing path by using the determined waypoint nodes in S960. Specific details regarding the path generation method will be described later.

First, with regard to obtaining the obstacle map, the obstacle map may be stored in the path generation device or may be obtained from the outside. Even though the obstacle map is stored in the path generation device, an obstacle map may be newly acquired from the outside to update the obstacle map.

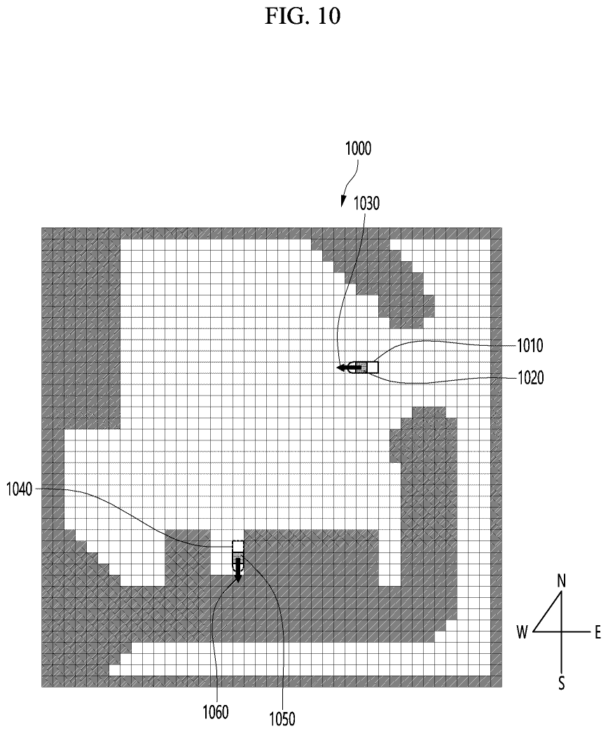

The selection of the current node and the berthing node on the obstacle map and the determination of the current heading direction at the current node and the berthing heading direction at the berthing node will be explained with reference to FIG. 10.

FIG. 10 is a drawing showing an obstacle map 1000 according to an embodiment.

Referring to FIG. 10, a current node 1020 may refer to a node corresponding to the current position of the vessel on the obstacle map 1000. The current node 1020 may correspond to the starting position of a path.

In the obstacle map 1000 of FIG. 10, the shape of the vessel is reflected at a position 1010 on the obstacle map 1000 corresponding to the current position of the vessel. However, the shape of the vessel is not limited thereto, and may not be reflected in the obstacle map.

The path generation device may receive coordinates of the current position of the vessel, etc. through the sensor module to obtain information about the current position of the vessel. Additionally, the path generation device may select the current node on the obstacle map by using the acquired information about the current position of the vessel.

In order to select the current node on the obstacle map, the scaling of the obstacle map and the mapping of the obstacle map to the absolute coordinate system may be performed by the path generation device.

In relation to the determination of the current position of the vessel for selecting the current node, the current position of the vessel may be determined based on the position of the center point of the vessel. The current position of the vessel is not limited thereto, and may be determined based on one point on the vessel, such as the bow or stern of the vessel.

Meanwhile, the path generation device may obtain the obstacle map 1000 with the current node 1020 selected from the outside.

Referring to FIG. 10, a berthing node 1050 may refer to a node corresponding to the berthing position of the vessel on the obstacle map 1000. The berthing node 1050 may correspond to the end location of the path.

In the obstacle map 1000 of FIG. 10, the shape of the vessel is reflected at a location 1040 on the obstacle map 1000 corresponding to the berthing position of the vessel, but this is not limited thereto, and the shape of the vessel may not be reflected in the obstacle map. The berthing position of the vessel refers to a position at which the vessel is to be berthed at the berthing facility, and may be determined based on data about a harbor stored in the path generation device or data obtained from the external server.

In relation to the determination of the berthing position of the vessel for selecting the berthing node, the berthing position of the vessel may be determined based on the position of the center point of the vessel when the vessel is berthed at the berthing facility. The determination is not limited thereto, and the berthing position of the vessel may be determined based on any point on the vessel, such as the bow or stern of the vessel. Meanwhile, the reference position of the vessel for selecting the current node and the reference position of the vessel for selecting the berthing node may be set to be the same.

Meanwhile, the path generation device may obtain the obstacle map 1000 with the berthing node 1050 selected from the outside.

The current heading direction of the vessel 1030 may be assigned to the selected current node 1020. The current heading direction 1030 refers to the heading direction of the vessel at a current point in time, and may be determined by using data acquired from the sensor module. Assigning the heading direction to nodes on the obstacle map has been described above, and thus a duplicate explanation will be omitted.

The selected berthing node 1050 may be assigned a berthing heading direction 1060. The berthing heading direction 1060 refers to a heading direction when the vessel is berthed at the berthing facility. The berthing heading direction 1060 may be determined based on information about the harbor stored in the path generation device or data acquired from the outside. When only information about the berthing position is received from the outside, the berthing heading direction 1060 may be determined from an expected heading direction when the vessel is located at the berthing position based on information about the harbor (the shape of the harbor, etc.) on the obstacle map 1000. Assigning the heading direction to the nodes on the obstacle map has been described above, and thus a duplicate explanation will be omitted.

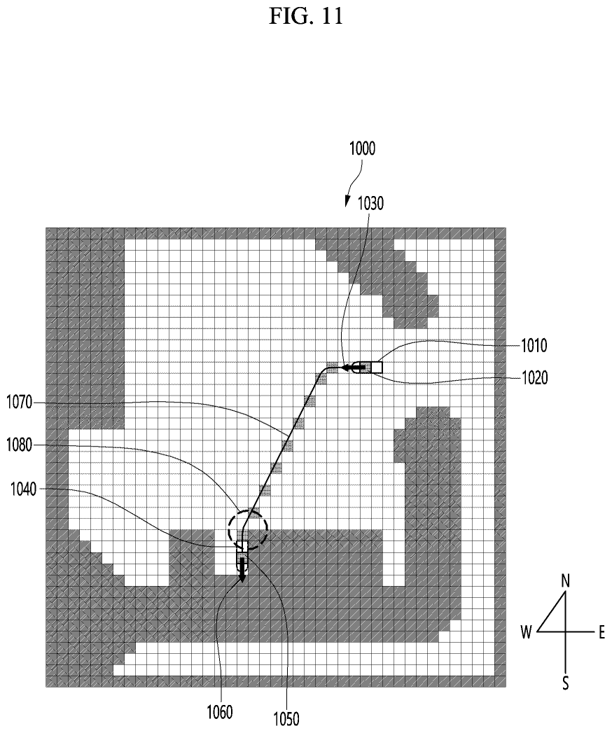

FIG. 11 is a drawing showing a path 1070 generated by performing the existing method of generating a berthing path on the obstacle map 1000 of FIG. 10.

Typically, a 3D A* algorithm may be used to generate a path, and FIG. 11 shows the path 1070 from the current node 1020 to the berthing node 1050 generated by using only the existing 3D A* algorithm.

Referring to FIG. 11, the existing 3D A* algorithm generates a shortest path 1070 from the current node 1020 to the berthing node 1050, and in the generated path 1070, a course change section 1080 with a short length exists just before the berthing facility.

Accordingly, there was a problem that the risk of collision between the vessel and the berthing facility increased even with a small path deviation when the vessel was navigated along the berthing path generated by the method of generating a berthing path using only the general 3D A* algorithm. To solve this, the present disclosure is intended to generate the berthing path by using the reference distance, which will be described later.

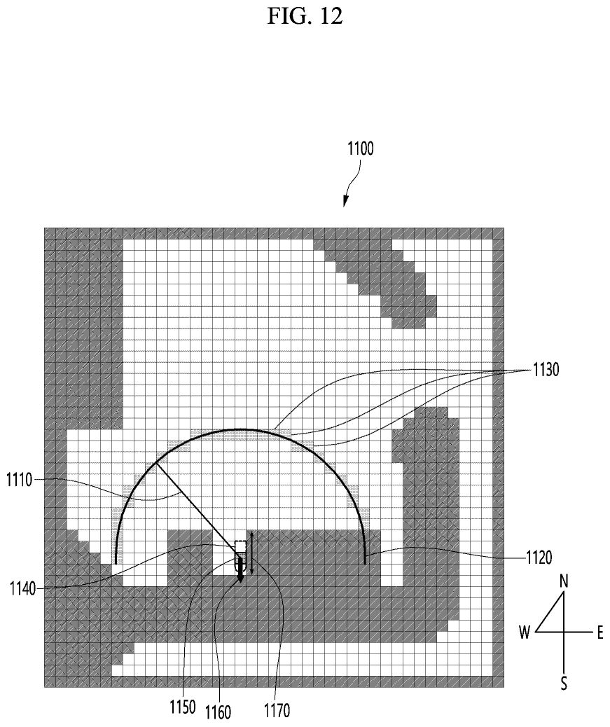

FIG. 12 is a drawing for explaining a reference distance 1110 according to an embodiment.

The reference distance 1110 refers to a distance that considers sufficient space for the vessel to turn 360 degrees and re-enter the berthing facility when difference between the heading direction of the vessel and the berthing heading direction 1160 thereof is large enough to make it difficult or dangerous for the vessel to enter the berthing facility directly during the berthing of the vessel at the berthing facility.

When generating a berthing path considering the reference distance 1110, the path generation device generates a path that minimizes change in the heading direction of the vessel within a reference distance range 1120 from a berthing node 1150, thereby reducing the risk of collision between the vessel and the berthing facility when navigating the vessel along the generated path.

Specifically, the reference distance 1110 may be calculated by considering at least one of the length of the vessel, the width of the vessel, the weight of the vessel, the steering performance of the vessel, and the length 1170 of the berthing facility. For example, the longer the vessel, the greater the width of the vessel, the greater the weight of the vessel, the lower the steering performance of the vessel, and the longer the length 1170 of the berthing facility, the longer the reference distance 1110 may be. Meanwhile, the reference distance 1110 may be calculated by considering the turning radius of the vessel. In this case, the longer the turning radius of the vessel, the longer the reference distance 1110 may be. Meanwhile, the reference distance 1110 may be calculated by considering the sum of twice the length 1170 of the berthing facility and five times the length of the vessel.

The reference distance 1110 may be calculated from the path generation device. Specifically, the path generation device may calculate the reference distance 1110 by using information about a vessel and information about a harbor stored in the path generation device. In this case, the information about the vessel and/or the information about the harbor may be data received from the outside.

Meanwhile, the reference distance 1110 may be calculated from the external server. Specifically, the external server may calculate the reference distance 1110 by using the information about the harbor stored in the external server and the information about the vessel received from the vessel. When the reference distance is calculated from the external server, the external server may transmit the calculated reference distance to the path generation device.

Referring to FIG. 12, reference distance nodes 1130 which are nodes corresponding to positions of the reference distance 1110 away from the berthing node 1150 may be used to generate a berthing path to be described later.

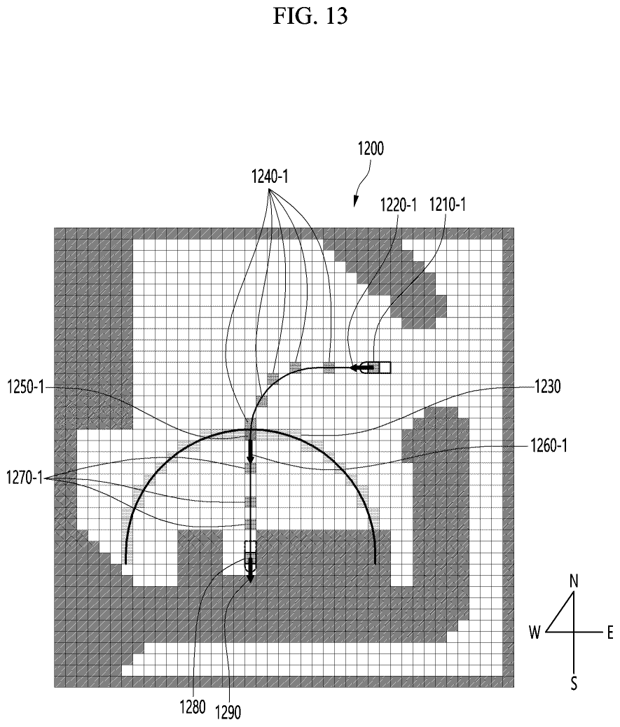

The determination of a plurality of waypoint nodes from the current node to the berthing node on the obstacle map and the berthing path generation will be described with reference to FIGS. 13, 14, and 15.

FIGS. 13, 14, and 15 are drawings showing berthing paths and waypoint nodes on an obstacle map 1200 according to an embodiment.

A path may refer to the sequence of at least two nodes, and determining the path may mean determining the nodes and their sequence.

A waypoint node may refer to a node on the obstacle map corresponding to a specific position of the vessel when the vessel moves from the current position to the berthing position along a path. In this case, the specific position may be the bow, stern or center point of the vessel. However, it is preferable that the specific position be determined to be the same as a position used when determining the current node corresponding to the current position of the vessel. For example, when the center point of the vessel is used when determining the current node, it is preferable that the center point of the vessel be used even when determining the waypoint node.

The method of determining waypoint nodes may be used to determine waypoint nodes on the obstacle map. For example, the method of determining waypoint nodes may include a method of determining first waypoint nodes and a method of determining second waypoint nodes. The specific method of determining waypoint nodes will be described with reference to FIG. 13.

Referring to FIG. 13, the method of determining first waypoint nodes is a method of determining a plurality of first waypoint nodes 1240-1 from a current node 1210-1 to one of reference distance nodes 1230 by considering a current heading direction 1220-1.

In this case, the first waypoint nodes 1240-1 may be determined by considering the maximum turning angle of the vessel. Specifically, a first waypoint node 1240-1 immediately following the current node 1210-1 may be determined from among nodes within the maximum turning angle based on the current heading direction 1220-1.

The method of determining first waypoint nodes may determine an expected heading direction at each of the determined first waypoint nodes 1240-1. Although not shown in FIG. 13, the determined expected heading direction may be assigned to corresponding waypoint nodes. An expected heading direction for a specific waypoint node means an expected heading direction of the vessel at a position corresponding to the specific waypoint node, assuming that the vessel moving along an expected path is located at the position corresponding to the specific waypoint node. Since the expected heading direction is assigned to each of the determined first waypoint nodes 1240-1, a subsequent first waypoint node immediately following a determined first waypoint node 1240-1 may be determined from among the nodes within the maximum turning angle based on the expected heading direction assigned to each of the determined first waypoint nodes 1240-1.

The maximum turning angle of the vessel may be a value proportional to the speed of the vessel and inversely proportional to the turning radius. In this case, the turning radius may be set to five times the length of the vessel. To take the maximum turning angle into account when determining the first waypoint nodes 1240-1, the maximum turning angle, speed, and/or turning radius at each node may be calculated.

Although not shown in FIG. 13, the method of determining a first waypoint node may determine the first waypoint node 1240-1 by considering a score assigned to each node of the obstacle map 1200 described above. Specifically, the method of determining first waypoint node may determine the first waypoint node by considering a score assigned to the subsequent first waypoint node when determining the subsequent first waypoint node immediately following the current node 1210-1 or the determined first waypoint node 1240-1. For example, among preliminary subsequent first waypoint nodes, a node with the lowest assigned score may be determined as the subsequent first waypoint node.

Additionally, the method of determining first waypoint nodes may determine the first waypoint nodes 1240-1 by considering the remaining distance to a berthing node 1280. Specifically, the method of determining first waypoint nodes may determine a subsequent first waypoint node such that the remaining distance from the subsequent first waypoint node to the berthing node 1280 decreases when determining the subsequent first waypoint node immediately following the current node 1210-1 or the determined first waypoint node 1240-1.

Meanwhile, in FIG. 13, the first waypoint nodes 1240-1 are determined such that there is a distance between the first waypoint nodes 1240-1, but the first waypoint nodes 1240-1 may be determined continuously from the current node 1210-1 to one of the reference distance nodes 1230.

The reference distance nodes 1230 considered to determine the first waypoint nodes 1240-1 refer to at least one node corresponding to a location that is the reference distance away from the berthing node 1280. Among the reference distance nodes 1230, a node determined as the first waypoint node 1240-1 may be set to the reference distance waypoint node 1250-1. In this case, a heading direction when the vessel is located at the reference distance waypoint node 1250-1, as an expected heading direction 1260-1, may be assigned to the reference distance waypoint node 1250-1.

The method of determining first waypoint nodes may determine the first waypoint nodes 1240-1 so that second waypoint nodes 1270-1 can be determined according to the method of determining second waypoint nodes to be described later.

Referring to FIG. 13, the method of determining second waypoint nodes is the method of determining the plurality of second waypoint nodes 1270-1 from the reference distance waypoint node 1250-1 to the berthing node 1280 by considering a berthing heading direction 1290.

In this case, the second waypoint nodes 1270-1 may be determined by considering the maximum turning angle of the vessel. Specifically, a second waypoint node 1270-1 immediately following the reference distance waypoint node 1250-1 may be determined from among nodes within the maximum turning angle based on the expected heading direction 1260-1 assigned to the reference distance waypoint node 1250-1.

The method of determining second waypoint nodes may determine an expected heading direction at each of the determined second waypoint nodes 1270-1. Although not shown in FIG. 13, the determined expected heading direction may be assigned to the corresponding waypoint nodes. The expected heading direction is assigned to each of the determined second waypoint nodes 1270-1, and accordingly, even when determining a subsequent second waypoint node immediately following the determined second waypoint node 1270-1, the subsequent second waypoint node may be determined from among nodes within the maximum turning angle based on the expected heading direction of the determined second waypoint node 1270-1.

Additionally, the method of determining second waypoint node may determine the second waypoint node 1270-1 so that the expected heading direction to be assigned to each of the second waypoint nodes 1270-1 corresponding to the berthing node 1280 corresponds to the berthing heading direction 1290.

Although not shown in FIG. 13, the method of determining second waypoint nodes may determine the second waypoint nodes 1270-1 by considering a score assigned to each of nodes of the obstacle map 1200 described above. Specifically, the method of determining second waypoint nodes may determine a second waypoint node by considering a score assigned to a subsequent second waypoint node when determining the subsequent second waypoint node immediately following the reference distance waypoint node 1250-1 or the determined second waypoint node 1270-1. For example, among preliminary subsequent second waypoint nodes, a node with the lowest assigned score may be determined as a subsequent second waypoint node.

Additionally, the method of determining second waypoint nodes may determine the second waypoint nodes 1270-1 by considering the remaining distance to the berthing node 1280. Specifically, the method of determining second waypoint nodes may determine the subsequent second waypoint node such that, when determining a subsequent second waypoint node immediately following the reference distance waypoint node 1250-1 or the determined second waypoint node 1270-1, the remaining distance from the subsequent second waypoint node to the berthing node 1280 decreases.

Meanwhile, in FIG. 13, the second waypoint nodes 1270-1 are determined so that there is a distance between the second waypoint nodes 1270-1. However, the second waypoint nodes 1270-1 may be determined continuously from the reference distance waypoint node 1250-1 to the berthing node 1280.

Compared with the method of determining first waypoint nodes, the method of determining second waypoint nodes may determine the subsequent second waypoint node by considering difference between the expected heading direction to be assigned to the subsequent second waypoint node and the berthing heading direction 1290 when determining the subsequent second waypoint node immediately following the reference distance waypoint node 1250-1 or the determined second waypoint node 1270-1. For example, among preliminary subsequent second waypoint nodes, a node with a smallest difference between the expected heading direction to be assigned to a corresponding node and the berthing heading direction 1290 may be determined as the subsequent second waypoint node.

Meanwhile, the method of determining second waypoint nodes may determine the subsequent second waypoint node by considering only difference between the expected heading direction to be assigned to the subsequent second waypoint node and the berthing heading direction 1290. Alternatively, the method of determining second waypoint nodes may determine a node among the preliminary subsequent second waypoint nodes, the expected heading direction of which is identical to the berthing heading direction 1290, as the subsequent second waypoint node.

That is, according to the method of determining second waypoint nodes, the second waypoint node 1270-1 is required to be determined such that difference between the expected heading direction to be assigned to each of the second waypoint nodes 1270-1 and the berthing heading direction 1290 is small or non-existent. Accordingly, the method of determining first waypoint nodes may determine the first waypoint node 1240-1 by considering whether the second waypoint node 1270-1 can be determined through the method of determining second waypoint nodes.

Specifically, even if the first waypoint nodes 1240-1 and the reference distance waypoint node 1250-1 are determined through the method of determining first waypoint nodes, when the second waypoint nodes 1270-1 from the reference distance waypoint node 1250-1 to the berthing node 1280 cannot be determined by using a second path generation method, at least one first waypoint node among the determined first waypoint nodes may be newly determined, or a new first waypoint node may be additionally determined.

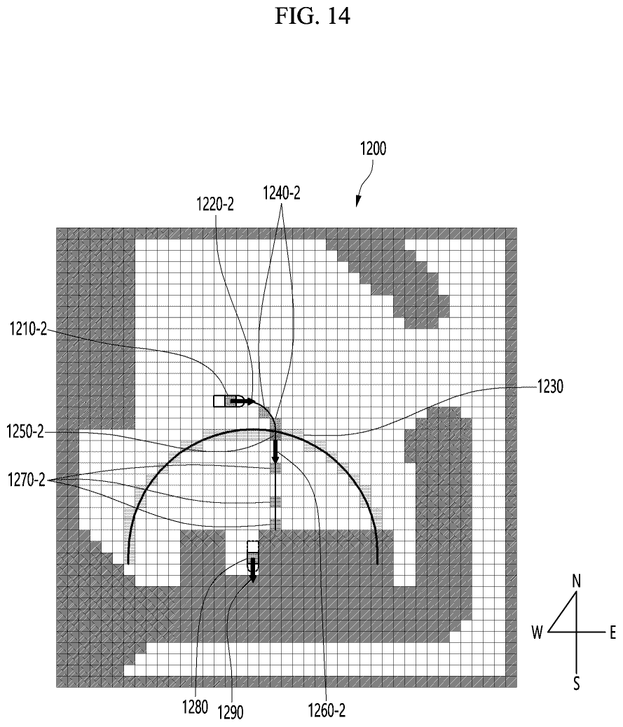

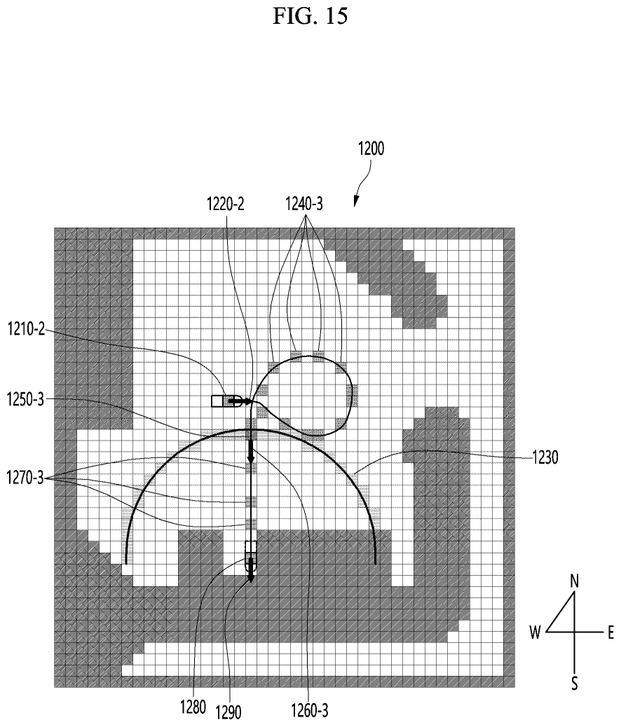

The new determination of the first waypoint node will be described with reference to FIGS. 14 and 15.

Referring to FIG. 14, under the condition that a current node 1210-2 is close to the reference distance nodes 1230 and a current heading direction 1220-2 has a large difference from the berthing heading direction 1290, when a shortest path is generated from the current node 1210-2 to one of the reference distance nodes 1230 by using a first path generation method, due to the limitation of the steering performance of the vessel, a reference distance waypoint node 1250-2 and an expected heading direction 1260-2 assigned to the reference distance waypoint node 1250-2 may unavoidably be determined as shown in FIG. 14.

In the state in which the reference distance waypoint node 1250-2 and the expected heading direction 1260-2 assigned to the reference distance waypoint node 1250-2 are determined as shown in FIG. 14, when second waypoint nodes 1270-2 are determined by using the method of determining second waypoint nodes described above, the second waypoint nodes 1270-2 are not generated up to the berthing node 1280. That is, the second waypoint nodes 1270-1 cannot be determined through the method of determining second waypoint nodes.

Accordingly, under the condition of the current node 1210-2 and the current heading direction 1220-2 as shown in FIG. 14, a new first waypoint node is required to be determined.

Referring to FIG. 15, in a condition in which the current node 1210-2 is located close to the reference distance nodes 1230 and the current heading direction 1220-2 has a large difference from the berthing heading direction 1290, the method of determining first waypoint nodes may determine first waypoint nodes 1240-3 so that the vessel can turn outside the reference distance and approach the reference distance nodes 1230.

Accordingly, as shown in FIG. 15, the method of determining second waypoint nodes may determine second waypoint nodes 1270-3 from a reference distance waypoint node 1250-3 to the berthing node 1280.

The method of determining waypoint nodes described above may be implemented based on the 3D A* algorithm.

Specifically, in order to obtain an expected berthing path, which is a path intended to be generated through the method of determining waypoint nodes described above, the expected berthing path cost function may be set as a cost function considered in the 3D A* algorithm.

Hereinafter, the method of determining a plurality of waypoint nodes from the current node to the berthing node on the obstacle map by using the reference distance and the expected berthing path cost function will be described.

Just as the method of determining waypoint nodes includes the method of determining first waypoint nodes and the method of determining second waypoint nodes, the expected berthing path cost function may include the first expected berthing path cost function and the second expected berthing path cost function.

The first expected berthing path cost function that can be applied to the first expected berthing path to be generated by the method of determining first waypoint nodes may be defined as follows. The cost function f=g+h, wherein g (n) and h (n) may be defined as follows.

$$\begin{matrix}g ( n ) = ω m * Cm ( n ) + ω c * Cc ( n ) \\ h ( n ) = ω d * Cd ( n )\end{matrix}$$

In this case, n represents the sequence number of a first waypoint node from the current node, and n may be 0 at the current node.

Meanwhile, om, wc, and od are weight values for Cm, Cc, and Cd, respectively.

Cm is a score assigned to each node in the obstacle map, and is intended to consider a safe position away from an obstacle. Cc is an angular change to the next node relative to the current heading direction or the expected heading direction in radians, and is intended to reflect the limited steering performance of the vessel. Cd is the remaining distance from the waypoint node to the berthing node and represents a heuristic value.

By using the cost function described above, the first waypoint node from the current node to the reference distance waypoint node may be determined.

For example, when determining an immediately subsequent node (e.g., an n+1th waypoint node) based on an nth waypoint node, cost values determined by the cost function may be calculated for each of a plurality of subsequent node candidates based on the nth waypoint node, and a subsequent node candidate with the smallest calculated cost value may be determined as the n+1th waypoint node. That is, in determining the n+1th subsequent waypoint node based on the nth waypoint node, a score assigned to each node of the obstacle map for considering a safe position from an obstacle, an angular change to the next node relative to the current heading direction or the expected heading direction in radians for reflecting the limited steering performance of the vessel, and the remaining distance from the waypoint node to the berthing node may be considered. This process may be repeated from the current node to the reference distance waypoint node so that a plurality of first waypoint nodes can be determined.

Meanwhile, the second expected berthing path cost function that can be applied to the second expected berthing path to be generated by the method of determining second waypoint nodes may be defined as follows. The cost function f=g+h, wherein g (n) and h (n) may be defined as follows.

$$\begin{matrix}g ( n ) = ω m * Cm ( n ) + ω c * Cc ( n ) \\ h ( n ) = ω d * Cd ( n ) + ω b * Cb ( n ) * A\end{matrix}$$

In this case, n represents the sequence number of a second waypoint node, and n may be 0 in the reference distance waypoint node.

Meanwhile, om, oc, od, and ob are weight values for Cm, Cc, Cd, and Cb, respectively. Since Cm, Cc, and Cd have been described above, a duplicate explanation will be omitted.

Cb is a difference between the expected heading direction and the berthing heading direction in radians at the waypoint node, and is intended to minimize the difference between the expected heading direction and the berthing heading direction.

A is a value set to increase the weight of difference between the expected heading direction and the berthing heading direction when using the method of determining second waypoint nodes. A maximum value in the form of a real number may be assigned to A. For example, when an infinite value is assigned to A, only the value of Cb may be considered when determining the second waypoint node. By giving A the infinite value (which may be the largest real number that can be set), as described above, the method of determining the second node may be interpreted as determining the subsequent second waypoint node by considering only difference between the expected heading direction and the berthing heading direction 1290 to be assigned to the subsequent second waypoint node when determining the subsequent waypoint node. However, when a suitably large real number instead of an infinite value is assigned to A, difference between the expected heading direction and the berthing heading direction 1290 to be assigned to the subsequent second waypoint node is taken into greatest consideration, and a score assigned to each node of the obstacle map for considering a safe position from an obstacle, an angular change to the next node relative to the current heading direction or the expected heading direction in radians for reflecting the limited steering performance of the vessel, and the remaining distance from the waypoint node to the berthing node may also be considered.

Meanwhile, when the difference between the expected heading direction and the berthing heading direction is large, ultimately the subsequent nodes cannot be determined, so a ‘new’ set of first waypoint nodes may be determined according to the method of determining first waypoint nodes, and as this loop is repeated, the purpose ultimately intended to be achieved by the present application can be achieved, and instead of a path with a high risk of collision as illustrated in FIG. 11, a safe path as illustrated in FIGS. 13 and 15 can be found.

By using the cost function described above, the second waypoint nodes from the reference distance waypoint node to the berthing node may be determined.

In summary, the expected berthing path cost function of the method of determining waypoint nodes based on the 3D A* algorithm may be defined as follows, where f=g+h, wherein g (n) and h (n) may be defined as follows.

$$\begin{matrix}g ( n ) = ω m * Cm ( n ) + ω c * Cc ( n ) \\ h ( n ) = ω d * Cd ( n ) \\ A = \{ \begin{matrix}∞ , {C}_{d} < reference distance \\ 0 , {C}_{d} \geq reference distance\end{matrix}\end{matrix}$$

In this case, n represents the sequence number of a waypoint node, and n may be 0 at the current node.

As a result, the method of determining the waypoint node (the reference distance waypoint node) arranged at the reference distance from the current node and the method of determining a berthing path from the reference distance waypoint node to the berthing position become different from each other.

More specifically, difference between the method of determining second waypoint nodes and the method of determining first waypoint node is that difference between an expected bow angle assigned to a subsequent node and a berthing angle assigned to the berthing node is taken into further consideration. Furthermore, the difference between the method of determining second waypoint nodes and the method of determining first waypoint nodes is that a weight value for the difference between the expected bow angle assigned to the subsequent node and the berthing angle assigned to the berthing node is set very large, so that the values considered in the method of determining first waypoint nodes (e.g., a score assigned to each node of the obstacle map for considering a safe position from an obstacle, an angular change to the next node based on the current heading direction or the expected heading direction in radians for reflecting the limited steering performance of the vessel, and the remaining distance from the waypoint node to the berthing node) have no or very small influence on the function value of the cost function.

By using the cost function described above, the plurality of waypoint nodes from the current node to the berthing node may be determined.

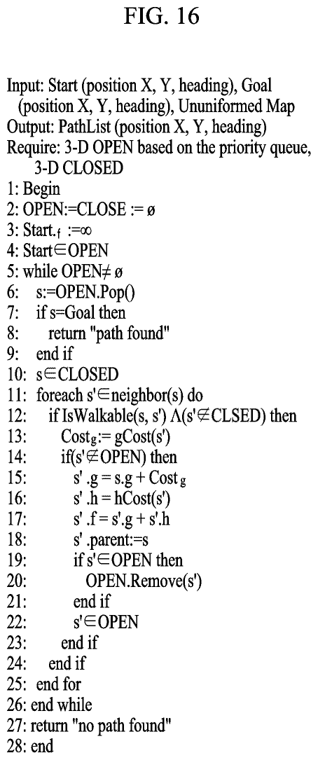

Specifically, the waypoint nodes may be determined by using the expected berthing path cost function described above and the algorithm of FIG. 16.

FIG. 16 is an exemplary algorithm for obtaining waypoint nodes and a path based on a 3D A* algorithm.

The path generation device may use the current node, the berthing node, and the waypoint nodes to generate a berthing path.

Specifically, the path generation device may generate a path by sequentially connecting the current node, the waypoint nodes, and the berthing node. The path generation device is not limited thereto, and may select some waypoint nodes suitable for navigation among the waypoint nodes, and sequentially connect the current node, the selected waypoint nodes, and the berthing node to generate a path. The path generation device may consider a heading direction assigned to each node when generating a path by sequentially connecting the nodes.

Meanwhile, the path generation device may generate a path by calculating an approximated curve for the waypoint nodes. The approximated curve may be calculated to pass through the current node and the berthing node by considering the current heading direction and the berthing heading direction. The degree of approximation for the waypoint nodes of the approximated curve may be determined based on information about the vessel.

Meanwhile, when waypoint nodes satisfying the above-described conditions are not determined by using the method of determining waypoint nodes described above due to the presence of an obstacle within the reference distance range, the path generation device may output a result indicating that a path cannot be generated.

### 4. Path Generation Method 2

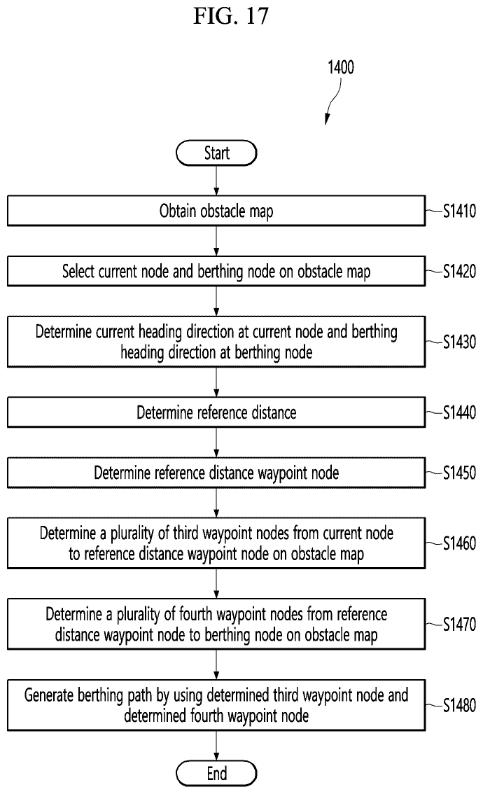

FIG. 17 is a flowchart of the path generation method according to an embodiment.

Referring to FIG. 17, the path generation method according to an embodiment of the present disclosure may be performed through the process of obtaining an obstacle map in S1410, selecting a current node and a berthing node on the obstacle map in S1420, determining a current heading direction at the current node and a berthing heading direction at the berthing node in S1430, determining a reference distance in S1440, determining a reference distance waypoint node on the obstacle map in S1450, determining a plurality of third waypoint nodes from the current node to the reference distance waypoint node on the obstacle map in S1460, determining a plurality of fourth waypoint nodes from the reference distance waypoint node to the berthing node on the obstacle map in S1470, and generating a berthing path by using the determined third waypoint nodes and fourth waypoint nodes in S1480. Specific details regarding the path generation method will be described later.

The contents related to obtaining the obstacle map, selecting the current node and the berthing node on the obstacle map, determining the current heading direction at the current node and the berthing heading direction at the berthing node, determining the reference distance, and generating the berthing path using the waypoint nodes have been described above, so a duplicate description will be omitted.

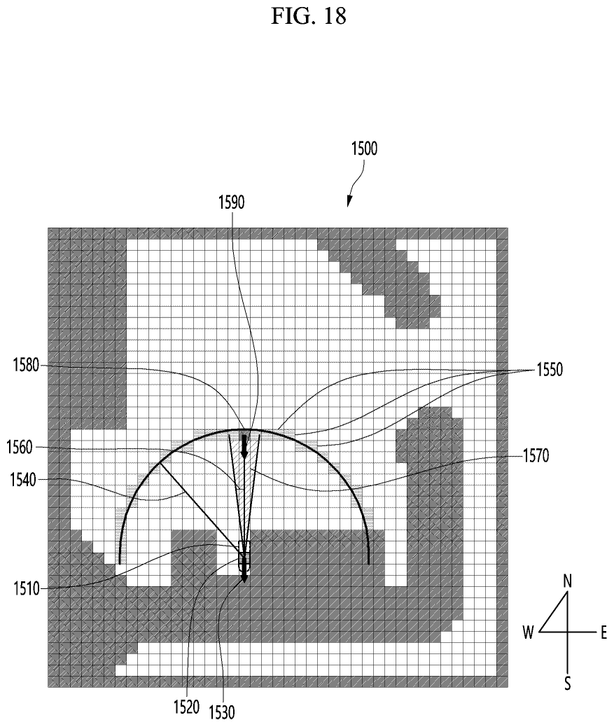

The determination of the reference distance waypoint node on the obstacle map will be described with reference to FIG. 18.

FIG. 18 is a drawing for explaining a method of determining a reference distance waypoint node according to an embodiment.

Referring to FIG. 18, the method of determining the reference distance waypoint node is a method of determining a reference distance waypoint node 1580, which is one of the reference distance nodes 1550 on an obstacle map 1500. Specifically, the reference distance waypoint node 1280 may be determined by considering at least one of a position of a berthing node 1520 on the obstacle map 1500, a berthing heading direction 1530, a reference distance 1540, a berthing threshold angle 1560, and information about a vessel.

The berthing threshold angle 1560 refers to a critical angle to minimize the course change of the vessel within the reference distance from the berthing position.

The berthing threshold angle 1560 may be determined by taking into account at least one of information about a vessel and information about a harbor. For example, when the steering performance of the vessel is high, the berthing threshold angle 1560 may be large, and when the steering performance of the vessel is low, the berthing threshold angle 1560 may be small. Meanwhile, the smaller the turning radius of the vessel, the larger the berthing threshold angle 1560 may be, and the larger the turning radius, the smaller the berthing threshold angle 1560 may be. Meanwhile, the shorter the length of a berthing facility, the larger the berthing threshold angle 1560 may be, and the longer the length of a berthing facility, the smaller the berthing threshold angle 1560 may be. Meanwhile, the berthing threshold angle 1560 may be determined as 0 degrees.

For example, the method for determining the reference distance waypoint node may determine one of the reference distance nodes 1550 located within a berthing threshold angle range 1570 based on a line extending from the berthing node 1520 in the berthing heading direction 1530 or in a direction opposite to the berthing heading direction 1530 as the reference distance waypoint node 1580. The method for determining the reference distance waypoint node is not limited thereto, and may determine one of the reference distance nodes 1550 on a line extending from the berthing node 1520 in the berthing heading direction 1530 or in the direction opposite to the berthing heading direction 1530 as the reference distance waypoint node 1580.

Referring to FIG. 18, the determined reference distance waypoint node 1580 may be assigned a reference distance heading direction 1590. The reference distance heading direction 1590 refers to an expected heading direction at the reference distance waypoint node 1580, and may be determined by considering at least one of the position of the reference distance waypoint node 1580, the position of the berthing node 1520, the berthing heading direction 1530, the reference distance 1540, the berthing threshold angle 1560, and information about the vessel.

For example, the reference distance heading direction 1590 may be determined as a direction from the reference distance waypoint node 1580 toward the berthing node 1520. The reference distance heading direction 1590 is not limited thereto, and may be determined such that difference between the reference distance heading direction 1590 and the berthing heading direction 1530 is within the berthing threshold angle 1560.

When the reference distance node 1550 on the line extending from the berthing node 1520 in the berthing heading direction 1530 or in the direction opposite to the berthing heading direction 1530 is determined as the reference distance waypoint node 1580, the reference distance heading direction 1590 may be the same as the berthing heading direction 1530.

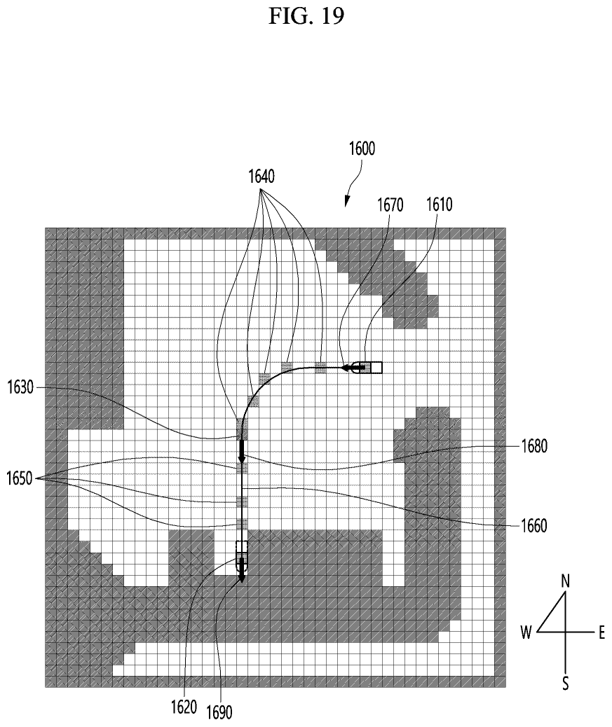

The determination of the plurality of third waypoint nodes from the current node to the reference distance waypoint node on the obstacle map and the determination of the plurality of fourth waypoint nodes from the reference distance waypoint node to the berthing node on the obstacle map will be described with reference to FIG. 19.

FIG. 19 is a drawing showing each node and a generated berthing path on an obstacle map according to an embodiment.

The meaning of the current node, the berthing node, the waypoint nodes, and the reference distance waypoint node has been described above, so a duplicate explanation will be omitted.

The method of determining waypoint nodes may be used to determine waypoint nodes on an obstacle map 1600. The method of determining waypoint nodes according to an example may include a method of determining third waypoint nodes and a method of determining fourth waypoint nodes.

The method of determining third waypoint nodes is a method of determining a plurality of third waypoint nodes 1640 from a current node 1610 to a reference distance waypoint node 1630 by considering the position of the current node 1610, a current heading direction 1670, the position of the reference distance waypoint node 1630, and a reference distance heading direction 1680.

Specifically, the method of determining third waypoint nodes may be used to determine the third waypoint nodes 1640 such that the expected heading direction to be assigned to each of the third waypoint nodes 1640 corresponding to the reference distance waypoint node 1630 is identical to the reference distance heading direction 1680.

For this purpose, the method of determining third waypoint nodes may determine the expected heading direction at each of the determined third waypoint nodes 1640. Although not shown in FIG. 19, the determined expected heading direction may be assigned to corresponding waypoint nodes.

Meanwhile, the third waypoint nodes 1640 may be determined by considering the maximum turning angle of the vessel. Specifically, a third waypoint node 1640 immediately following the current node 1610 may be determined from among nodes within the maximum turning angle based on the current heading direction 1670.

Since the expected heading direction is assigned to each of the third waypoint nodes 1640 determined as described above, a subsequent third waypoint node immediately following the determined third waypoint node 1640 may be determined from among nodes within the maximum turning angle based on the expected heading direction assigned to the determined third waypoint node 1640. Since the maximum turning angle has been described above, a duplicate explanation will be omitted.

Although not shown in FIG. 19, the method of determining third waypoint nodes may determine the third waypoint nodes 1640 by considering a score assigned to each node of the obstacle map 1600 described above.

Specifically, the method of determining third waypoint nodes may determine the third waypoint nodes by considering a score assigned to the subsequent third waypoint node when determining the subsequent third waypoint node immediately following the current node 1610 or the determined third waypoint node 1640. For example, among preliminary subsequent third waypoint nodes, a node with the lowest assigned score may be determined as the subsequent third waypoint node.

Additionally, the method of determining third waypoint nodes may determine the third waypoint nodes 1640 by considering the remaining distance to the reference distance waypoint node 1630. Specifically, the method of determining third waypoint nodes may determine the subsequent third waypoint node such that, when determining the subsequent third waypoint node immediately following the current node 1610 or the determined third waypoint node 1640, the remaining distance from the subsequent third waypoint node to the reference distance waypoint node 1630 decreases.

In addition, the method of determining third waypoint nodes may determine the subsequent third waypoint node by considering difference between the expected heading direction to be assigned to the subsequent third waypoint node and the reference distance heading direction 1680 when determining the subsequent third waypoint node immediately following the current node 1610 or the determined third waypoint node 1640. For example, among the preliminary subsequent third waypoint nodes, a node with the smallest difference between the expected heading direction to be assigned to a corresponding node and the reference distance heading direction of 1680 may be determined as the subsequent third waypoint node.

Meanwhile, in FIG. 19, the third waypoint nodes 1640 are determined so that there is a distance between the third waypoint nodes 1640. However, the third waypoint nodes 1640 may be determined continuously from the current node 1610 to the reference distance waypoint node 1630.

The method of determining third waypoint nodes according to an embodiment may be implemented based on the 3D A* algorithm.

Specifically, a cost function considered in the 3D A* algorithm, f=g+h, wherein g (n) and h(n) may be defined as follows.

$$\begin{matrix}g ( n ) = ω m * Cm ( n ) + ω c * Cc ( n ) \\ h ( n ) = ω d * Cd ( n ) + ω b * Cb ( n )\end{matrix}$$

In this case, n represents the sequence number of a third waypoint node, and n may be 0 at a current node.

Meanwhile, om, wc, od, and ob are weight values for Cm, Cc, Cd, and Cb, respectively.

Cm is a score assigned to each node in the obstacle map, and is intended to consider a safe location away from an obstacle. Cc is an angular change to the next node relative to the current heading direction or the expected heading direction in radians, and is intended to reflect the limited steering performance of the vessel. Cd is the remaining distance from the waypoint node to the reference distance waypoint node and represents a heuristic value. Cb is difference between the expected heading direction and the reference distance heading direction in radians at the waypoint node, and is intended to minimize the difference between the expected heading direction and the reference distance heading direction.

By using the cost function described above, the third waypoint nodes from the current node to the reference distance waypoint node may be determined.

The method of determining fourth waypoint nodes is a method of determining a plurality of fourth waypoint nodes 1650 from the reference distance waypoint node 1630 to a berthing node 1620 by considering the position of the reference distance waypoint node 1630, the reference distance heading direction 1680, the position of the berthing node 1620, and a berthing heading direction 1690.

Specifically, the method of determining fourth waypoint nodes may be used to determine the fourth waypoint nodes 1650 such that the expected heading direction to be assigned to a fourth waypoint node 1650 corresponding to the berthing node 1620 is identical to the berthing heading direction 1690.

For this purpose, the method of determining fourth waypoint nodes may determine the expected heading direction at each of the determined fourth waypoint nodes 1650. Although not shown in FIG. 19, the determined expected heading direction may be assigned to corresponding waypoint nodes.

Meanwhile, the method of determining fourth waypoint nodes may determine the fourth waypoint nodes 1650 by considering the maximum turning angle of the vessel, a score assigned to each node of the obstacle map 1600, the remaining distance to a berthing position 1620, which is an arrival position, and the berthing heading direction 1690, which is a direction at the arrival position, as in the method of determining third waypoint nodes described above. The specific method has been described in the method of determining third waypoint nodes, so a duplicate explanation is omitted.

The method of determining fourth waypoint nodes according to an embodiment may be implemented based on the 3D A* algorithm.

Specifically, the cost function of the method of determining fourth waypoint nodes may be identical to the cost function of the method of determining third waypoint nodes.

However, when there is difference between the cost function of the method of determining fourth waypoint nodes and the cost function of the method of determining third waypoint nodes, in the cost function of the method of determining fourth waypoint nodes, Cd refers to the remaining distance from the waypoint node to the berthing node, and Cb refers to a difference value between the expected heading direction and the berthing heading direction in radians at the waypoint node.

The fourth waypoint nodes 1650 from the reference distance waypoint node 1630 to the berthing node 1620 may be determined by using the cost function described above.

Referring to FIG. 19, a berthing path 1660 from the current node 1610 to the berthing node 1620 may be generated by using the determined third waypoint nodes 1640 and the determined fourth waypoint nodes 1650.

Specifically, the path generation device may generate the berthing path 1660 by sequentially connecting the determined third waypoint nodes 1640 from the current node 1610 to the reference distance waypoint node 1630 on the obstacle map 1600 and by sequentially connecting the determined fourth waypoint nodes 1650 from the reference distance waypoint node 1630 to the berthing node 1620. The path generation device is not limited thereto, and may select some waypoint nodes suitable for navigation among the determined third waypoint nodes 1640 and the determined fourth waypoint nodes 1650, and may generate a berthing path by using the selected waypoint nodes. The path generation device may consider a heading direction assigned to each node when generating a path.

Meanwhile, the path generation device may generate a path by calculating an approximate curve for the waypoint nodes. Specifically, the path generation device may generate a first approximation curve passing through the current node and the reference distance waypoint node by considering the current heading direction and the reference distance heading direction, and may generate a second approximation curve passing through the reference distance waypoint node and the berthing node by considering the reference distance heading direction and the berthing heading direction, and may generate a berthing path by using the first approximation curve and the second approximation curve. The degree of approximation for waypoint nodes of the approximation curves may be determined based on information about the vessel.

Meanwhile, when waypoint nodes satisfying the above-described conditions are not determined by using the method of determining waypoint nodes described above due to the presence of an obstacle within the reference distance range, the path generation device may output a result indicating that a path cannot be generated.

### 5. Path Following Control

Path following control means generating vessel control signals so that the vessel can navigate along a generated path. For example, the vessel navigation device may generate vessel control signals.

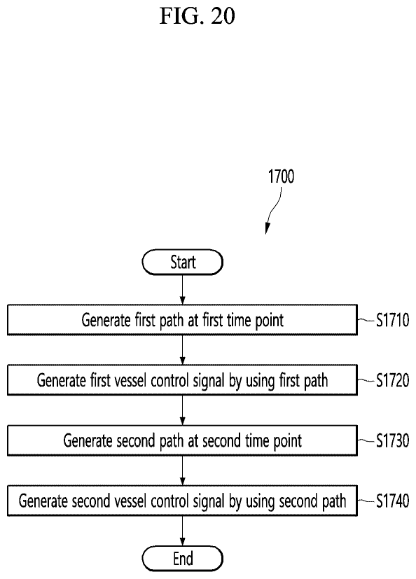

FIG. 20 is a flowchart of a path following control method according to an embodiment.

Referring to FIG. 20, the path following control method according to an embodiment of the present disclosure may be performed through the process of generating a first path at a first time point in S1710, generating a first vessel control signal by using the first path in S1720, generating a second path at a second time point later than the first time point in S1730, and generating a second vessel control signal by using the second path in S1740. Specific details regarding the path following control will be described later.

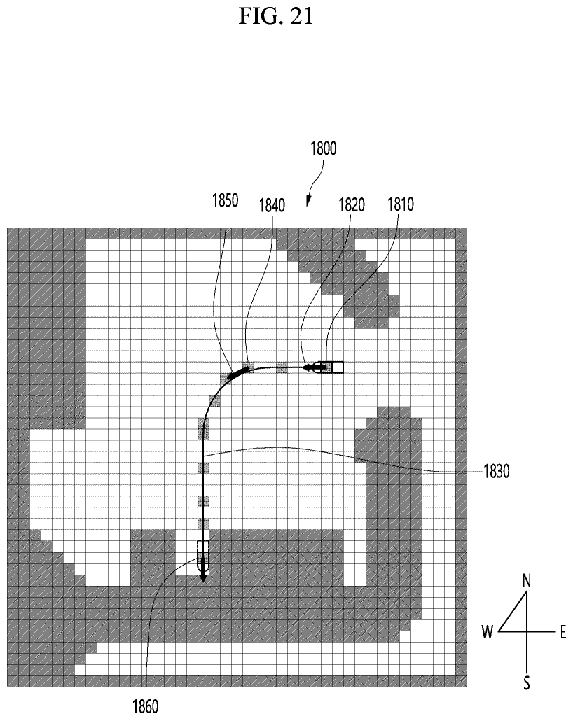

The generation of the first path and the generation of the first control signal at the first time point will be described with reference to FIG. 21.

FIG. 21 is a drawing for describing the path following control according to an embodiment.

Referring to FIG. 21, in order to perform the path following control method, a first berthing path 1830 may be generated by using an obstacle map 1800. Specifically, the obstacle map 1800 may be an obstacle map acquired at the first time point, or may be an obstacle map acquired before the first time point.

A first current node 1810 corresponding to a current position at the first time point on the obstacle map 1800 may be selected, and a berthing node 1860 corresponding to a berthing position may be selected.

Afterwards, a first path 1830 may be generated by using the path generation method described above. Since specific details regarding the berthing path generation have been described above, a duplicate explanation will be omitted.

After the first path is generated at the first time point, the first control signal may be generated so that the vessel can navigate along the first path. The first control signal may include a first vessel direction control signal and/or a first vessel speed control signal.

The first control signal may be generated by considering a current heading direction 1820 assigned to the current node 1810 such that the heading direction of the vessel at one subsequent waypoint node 1840 among the subsequent waypoint nodes following the current node 1810 belonging to the generated first path 1830 when the vessel is actually located at the subsequent waypoint node 1840 may be identical to an expected heading direction 1850 assigned to the subsequent waypoint node as much as possible.

That is, the first control signal may be generated by considering the current node 1810 corresponding to the current position of the vessel on the generated first path 1830, the current heading direction 1820, at least one subsequent waypoint node 1840 for the current node, and the expected heading direction 1850 assigned to the subsequent waypoint node.

Specifically, the first control signal may be generated by considering difference between the current heading direction 1820 assigned to the current node 1810 and the expected heading direction 1850 assigned to the subsequent waypoint node 1840. By considering the difference, the first vessel direction control signal, which is a control signal for adjusting the rudder or helm of the vessel, may be generated.

Meanwhile, the first vessel speed control signal, which is a control signal for controlling the propeller rotation speed or the number of rotations per unit time of the vessel or controlling the output of an engine, may be generated by considering at least one of the current speed of the vessel, difference between the current heading direction 1820 and the expected heading direction 1850, the current steering performance of the vessel, current direction and strength of a tidal current, and current wind direction and wind speed.

The vessel direction control signal and the vessel speed control signal may be generated independently of each other. That is, the vessel direction control signal may be generated regardless of the value of the vessel speed control signal, and the vessel speed control signal may be generated regardless of the value of the vessel direction control signal.

The vessel direction control signal is not limited thereto and may also be generated by considering the value of the vessel speed control signal. The vessel speed control signal may also be generated by considering the values of the vessel direction control signal. That is, vessel direction control and vessel speed control may influence each other.

Meanwhile, the control signals may be generated by using an artificial neural network trained to receive data on the status of the vessel and the surrounding environment, such as a distance from the current node to the subsequent waypoint node and difference in the heading direction, and output the vessel direction control signal or the vessel speed control signal.

An artificial neural network, which is a type of algorithm modeled after a human neural network structure, may include one or more layers including one or more nodes or neurons, wherein each node may be connected via synapses. Data (input data) input into the artificial neural network may be output (output data) through nodes via synapses, and through this, information may be obtained.

Types of artificial neural networks include convolutional neural networks (CNNs) that extract features by using filters, and recurrent neural networks (RNNs) that have a structure into which the output of a node is fed back as an input. In addition to these, there are various types of artificial neural networks, such as restricted Boltzmann machines (RBMs), deep belief networks (DBNs), generative adversarial networks (GANs), and relation networks (RNs).

Other path following may be performed by using a path following algorithm. For example, for path following, it is possible to use algorithms such as model predictive control (MPC), pure pursuit control, the Stanley method, and vector pursuit control which are technologies that generate an optimal control signal by receiving a position to be followed for an arbitrary time T from a current time point in time.

Meanwhile, to perform the path following control method, the second path may be generated at the second time point, which is a time point after the first time point. A time interval between the second time point and the first time point may be a predetermined time interval. For example, the time interval may be set to 150 ms to 250 ms.

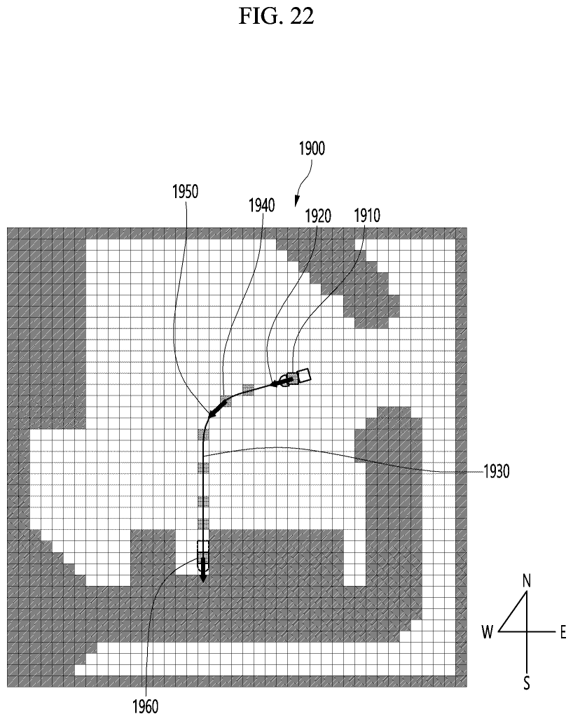

The generation of the second path and the generation of a second control signal at the second time point will be described with reference to FIG. 22.

FIG. 22 is a drawing for explaining the path following control according to an embodiment.

Referring to FIG. 22, to perform the path following control method, a second berthing path 1930 may be generated by using an obstacle map 1900.

Specifically, the obstacle map 1900 may be an obstacle map acquired at the second time point, or may be an obstacle map acquired at the first time point, or may be an obstacle map acquired at a previous time point.

A second current node 1910 corresponding to a current position at the second time point on the obstacle map may be selected, and a berthing node 1960 corresponding to a berthing position may also be selected. In this case, the berthing node 1960 may be the same as the berthing node 1860 selected at the first time point, or the berthing node 1960 may be newly selected at the second time point.

After that, a second path 1930 may be generated by using the path generation method described above. The generated second path 1930 may be identical to the first path 1830, or they may be different from each other.

Referring to FIG. 22, the generated second path 1930 may be different from the first path 1830 of FIG. 21.

Specifically, when there is a change in the obstacle map, for example, a change in the position of an obstacle, a change in the state of an obstacle, or when the vessel cannot follow the first path between the first time point and the second time point due to an external force or navigation limitation, the second path 1930 may be different from the first path 1830. The second path 1930 is not limited thereto, and may be generated differently from the first path 1830 due to other internal or external factors.

After the second path is generated at the second time point, the second control signal may be generated to allow the vessel to navigate along the second path. Since the details related to the control signal generation have been described above, a duplicate explanation will be omitted.

The path following control method described above may be repeated until an nth time point so that the vessel can be berthed at a berthing facility.

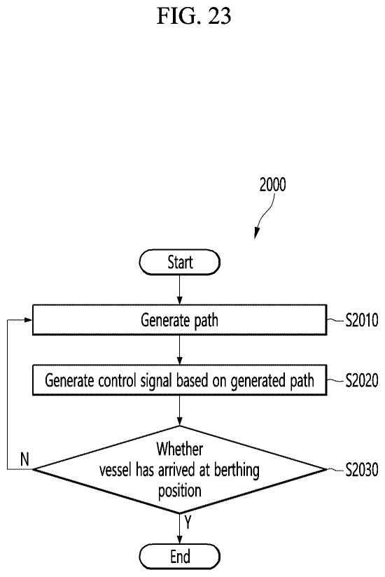

FIG. 23 is a flowchart of a vessel berthing method using the path following control according to an embodiment.

Referring to FIG. 23, the vessel berthing method using the path following control according to an embodiment of the present disclosure may be performed through the process of generating a path by using an obstacle map in S2010, generating a control signal based on the generated path in S2020, and repeating the path generation and the control signal generation depending on whether a vessel has arrived at a berthing position in S2030. Since the contents related to the path generation and the control signal generation have been described above, a duplicate explanation will be omitted.

Meanwhile, the path generation may be performed in the path generation device, and the control signal generation may be performed in the vessel navigation device. When the path generation device is located outside the vessel, the vessel navigation device may receive information about a berthing path and each node from the path generation device and generate the vessel control signal.

The method according to the embodiment may be implemented in the form of program commands that can be executed through various computer means and recorded on a machine-readable medium. The machine-readable medium may include program commands, data files, data structures, etc., alone or in combination. The program commands recorded on the medium may be specially designed and configured for the embodiment or may be known and available to those skilled in the art of computer software. Examples of machine-readable recording media include magnetic media such as a hard disk, a floppy disk, and a magnetic tape, optical media such as a CD-ROM and a DVD, magneto-optical media such as a floptical disk, and a hardware device specifically configured to store and execute program instructions, such as ROM, RAM, and flash memory. Examples of program instructions include a machine language code, such as that produced by a compiler, as well as a high-level language code that can be executed by a computer by using an interpreter, etc. The aforementioned hardware device may be configured to operate as one or more software modules to perform the operation of the embodiment, and vice versa.

The present disclosure described above is not limited to the above-described embodiments and the attached drawings, as various substitutions, modifications, and changes can be made within the scope that does not depart from the technical idea of the present disclosure by those skilled in the art to which the present disclosure belongs. In addition, the embodiments described in this document are not limited in application, and all or part of each embodiment may be selectively combined and configured so that various modifications can be made. Furthermore, steps constituting each embodiment may be utilized individually or in combination with steps constituting other embodiments.

Description of the sign

| | |
|---|---|
| 10 berthing guide system | 100 path generation device |
| 200 sensor module | 300 external server |
| 400 vessel navigation device | |

1. A berthing path generation method for a vessel, the method comprising:
obtaining an obstacle map including a plurality of nodes;
selecting a current node corresponding to a current position of the vessel and a berthing node corresponding to a berthing position on the obstacle map;
determining a current heading direction of the vessel at the current node and a berthing heading direction at the berthing node;
determining a reference distance by considering at least one of a length of the vessel, a width of the vessel, a weight of the vessel, a steering performance of the vessel, and a length of a berthing area;
determining, by using the reference distance and a predetermined expected berthing path cost function, a plurality of waypoint nodes from the current node to the berthing node and expected heading directions assigned to the plurality of waypoint nodes respectively on the obstacle map, wherein each of the plurality of waypoint nodes corresponds to at least one of the plurality of nodes; and
generating the berthing path by using the determined plurality of waypoint nodes;
wherein the predetermined expected berthing path cost function includes, for the vessel located at a position farther than the reference distance from the berthing position,
a first expected berthing path cost function applied to a first expected berthing path from the current node to a reference distance waypoint node, considering the current heading direction, and
a second expected berthing path cost function applied to a second expected berthing path from the reference distance waypoint node to the berthing node, and
wherein the first expected berthing path cost function is different from the second expected berthing path cost function.

2. The berthing path generation method of claim 1,
wherein the reference distance waypoint node is one of reference distance nodes corresponding to a position located at the reference distance from the berthing node.

3. The berthing path generation method of claim 2,
wherein the reference distance waypoint node is a node corresponding to a position located at the reference distance from the berthing node in the berthing heading direction or in a direction opposite to the berthing heading direction.

4. The berthing path generation method of claim 1,
wherein the second expected berthing path cost function includes a term that considers the berthing heading direction.

5. The berthing path generation method of claim 4,
wherein the term that considers the berthing heading direction is a term that considers a difference between an expected heading direction assigned to a waypoint node on the second expected berthing path and the berthing heading direction.

6. The berthing path generation method of claim 1,
wherein in the obstacle map, a score based on navigational safety of the vessel is assigned to each of the plurality of nodes, and
wherein expected berthing path cost function includes a term that considers the score.

7. The berthing path generation method of claim 1,
wherein the determining the plurality of waypoint nodes includes:
determining a current speed of the vessel, and
calculating a maximum turning angle of the vessel based on the current speed,
wherein the expected berthing path cost function includes a term that considers the maximum turning angle.

8. A berthing path generation device for a vessel, the device comprising:
a memory storing information for the vessel, information for a port, and a method of determining waypoint nodes; and
at least one processor;
wherein the processor is configured to:
obtain an obstacle map including a plurality of nodes,
select a current node corresponding to a current position of the vessel and a berthing node corresponding to a berthing position on the obstacle map,
determine a current heading direction of the vessel at the current node and a berthing heading direction at the berthing node;
determine a reference distance by considering at least one of a length of the vessel, a width of the vessel, a weight of the vessel, a steering performance of the vessel, and a length of a berthing facility;
determine, by using the reference distance and a predetermined expected berthing path cost function, a plurality of waypoint nodes from the current node to the berthing node and an expected heading direction assigned to the plurality of waypoint nodes respectively on the obstacle map, wherein each of the plurality of the waypoint nodes corresponds to at least one of the plurality of nodes; and
generate the berthing path by using the determined plurality of waypoint nodes;
wherein the predetermined expected berthing path cost function includes, for the vessel located at a position farther than the reference distance from the berthing position,
a first expected berthing path cost function applied to a first expected berthing path from the current node to a reference distance waypoint node, considering the current heading direction, and
a second expected berthing path cost function applied to a second expected berthing path from the reference distance waypoint node to the berthing node, and
wherein the first expected berthing path cost function is different from the second expected berthing path cost function.

9. The berthing path generation device of claim 8,
wherein the reference distance waypoint node is one of reference distance nodes corresponding to a position located at the reference distance from the berthing node.

10. The berthing path generation device of claim 9,
wherein the reference distance waypoint node is a node corresponding to a position located at the reference distance from the berthing node in the berthing heading direction or in a direction opposite to the berthing heading direction.

11. The berthing path generation device of claim 8,
wherein the second expected berthing path cost function includes a term that considers the berthing heading direction.

12. The berthing path generation device of claim 11,
wherein the term that considers the berthing heading direction considers a difference between an expected heading direction assigned to a waypoint node on the second expected berthing path and the berthing heading direction.

13. The berthing path generation device of claim 8,
wherein in the obstacle map, a score based on navigational safety of the vessel is assigned to each of the plurality of nodes, and
wherein expected berthing path cost function includes a term that considers the score.

14. The berthing path generation device of claim 8,
wherein the determining the plurality of waypoint nodes includes:
determining a current speed of the vessel, and
calculating a maximum turning angle of the vessel based on the current speed,
wherein the expected berthing path cost function includes a term that considers the maximum turning angle.

15. A non-transitory computer-readable recording medium storing a berthing path generation method,
wherein the berthing path generation method is berthing path generation method according to claim 1.
